(19) United States
(12) Patent Application Publication
(10) Pub. No.: US 2026/0370826 A1
(43) Pub. Date: Nov. 19, 2026

(54) METHOD, APPARATUS, AND MEDIUM FOR VISUAL DATA PROCESSING

(71) Applicants: Douyin Vision Co., Ltd., Beijing (CN); Bytedance Inc., Los Angeles, CA (US)

(72) Inventors: Semih ESENLIK, Los Angeles, CA (US); Zhaobin ZHANG, Los Angeles, CA (US); Ye-Kui WANG, Los Angeles, CA (US); Yaojun WU, Beijing (CN); Jizheng XU, Los Angeles, CA (US); Kai ZHANG, Los Angeles, CA (US); Li ZHANG, Los Angeles, CA (US)

(21) Appl. No.: 19/738,267

(22) Filed: Jul. 10, 2026

Related U.S. Application Data
(63) Continuation of application No. PCT/CN2025/071906, filed on Jan. 10, 2025.

(30) Foreign Application Priority Data
Jan. 13, 2024 (WO) PCT/CN2024/072197

(51) Int. Cl. H04N 19/119; H04N 19/172; H04N 19/42

(52) U.S. Cl. CPC H04N 19/119; H04N 19/172; H04N 19/42

(57) ABSTRACT

Embodiments of the present disclosure provide a solution for visual data processing. A method for visual data processing is proposed. The method comprises: performing a conversion between visual data and a codestream of the visual data with a neural network (NN)-based model, wherein samples associated with the visual data are partitioned into a plurality of partitions, and the codestream is allowed to comprise at least one of the following: a first indication indicating an amount of overlap for the plurality of partitions that is used in a hyper decoding process of the NN-based model, or a second indication indicating an amount of overlap for the plurality of partitions that is used in a multistage context modelling (MCM) process of the NN-based model.

### CROSS REFERENCE TO RELATED APPLICATIONS

This application is a continuation of International Application No. PCT/CN2025/071906, filed on Jan. 10, 2025, which claims the benefit of International Application No. PCT/CN2024/072197, filed on Jan. 13, 2024. The entire contents of these applications are hereby incorporated by reference in their entireties.

### FIELDS

Embodiments of the present disclosure relates generally to visual data processing techniques, and more particularly, to neural network-based visual data coding.

### BACKGROUND

The past decade has witnessed the rapid development of deep learning in a variety of areas, especially in computer vision and image processing. Neural network was invented originally with the interdisciplinary research of neuroscience and mathematics. It has shown strong capabilities in the context of non-linear transform and classification. Neural network-based image/video compression technology has gained significant progress during the past half decade. It is reported that the latest neural network-based image compression algorithm achieves comparable rate-distortion (R-D) performance with Versatile Video Coding (VVC). With the performance of neural image compression continually being improved, neural network-based video compression has become an actively developing research area. However, coding flexibility of neural network-based image/video coding is generally expected to be further improved.

### SUMMARY

Embodiments of the present disclosure provide a solution for visual data processing.

In a first aspect, a method for visual data processing is proposed. The method comprises: performing a conversion between visual data and a codestream of the visual data with a neural network (NN)-based model, wherein samples associated with the visual data are partitioned into a plurality of partitions, and the codestream is allowed to comprise at least one of the following: a first indication indicating an amount of overlap for the plurality of partitions that is used in a hyper decoding process of the NN-based model, or a second indication indicating an amount of overlap for the plurality of partitions that is used in a multistage context modelling (MCM) process of the NN-based model.

Based on the method in accordance with the first aspect of the present disclosure, samples associated with the visual data are partitioned into a plurality of partitions, and an amount of overlap for the plurality of partitions that is used in one or more processes of the NN-based model is indicated in the codestream. Compared with the conventional solution where the amount of overlap is fixed and predetermined, the proposed method can provide a mechanism for signaling of overlap amount information, and thus can better support the application of different overlap amounts for different processes. Thereby, the coding flexibility can be improved.

In a second aspect, an apparatus for visual data processing is proposed. The apparatus comprises a processor and a non-transitory memory with instructions thereon. The instructions upon execution by the processor, cause the processor to perform a method in accordance with the first aspect of the present disclosure.

In a third aspect, a non-transitory computer-readable storage medium is proposed. The non-transitory computer-readable storage medium stores instructions that cause a processor to perform a method in accordance with the first aspect of the present disclosure.

In a fourth aspect, another non-transitory computer-readable recording medium is proposed. The non-transitory computer-readable recording medium stores a codestream of visual data which is generated by a method performed by an apparatus for visual data processing. The method comprises: performing a conversion between the visual data and the codestream with a neural network (NN)-based model, wherein samples associated with the visual data are partitioned into a plurality of partitions, and the codestream is allowed to comprise at least one of the following: a first indication indicating an amount of overlap for the plurality of partitions that is used in a hyper decoding process of the NN-based model, or a second indication indicating an amount of overlap for the plurality of partitions that is used in a multistage context modelling (MCM) process of the NN-based model.

In a fifth aspect, a method for storing a codestream of visual data is proposed. The method comprises: performing a conversion between the visual data and the codestream with a neural network (NN)-based model; and storing the codestream in a non-transitory computer-readable recording medium, wherein samples associated with the visual data are partitioned into a plurality of partitions, and the codestream is allowed to comprise at least one of the following: a first indication indicating an amount of overlap for the plurality of partitions that is used in a hyper decoding process of the NN-based model, or a second indication indicating an amount of overlap for the plurality of partitions that is used in a multistage context modelling (MCM) process of the NN-based model.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1A illustrates a block diagram that illustrates an example visual data coding system, in accordance with some embodiments of the present disclosure;

FIG. 1B is a schematic diagram illustrating an example transform coding scheme;

FIG. 2 illustrates example latent representations of an image;

FIG. 3 is a schematic diagram illustrating an example autoencoder implementing a hyperprior model;

FIG. 4 is a schematic diagram illustrating an example combined model configured to jointly optimize a context model along with a hyperprior and the autoencoder;

FIG. 5 illustrates an example encoding process;

FIG. 6 illustrates an example decoding process;

FIG. 7 illustrates an example decoding process according to some embodiments of the present disclosure;

FIG. 8 illustrates an example learning-based image codec architecture;

FIG. 9 illustrates an example synthesis transform for learning based image coding;

FIG. 10 illustrates an example leaky Rectified Linear Unit (ReLU) activation function;

FIG. 11 illustrates an example ReLU activation function;

FIG. 12 illustrates latent tiles in synthesis transform;

FIG. 13 illustrates a bitstream layout;

FIG. 14 illustrates an example decoder structure;

FIG. 15 illustrates an example hyper scale decoder;

FIG. 16 illustrates an example hyper decoder;

FIG. 17 illustrates a diagram of an example multistage context modelling (MCM) structure;

FIG. 18 illustrates an example implementation of primary component guided adaptive up-sampling filter;

FIG. 19 illustrates an example bitstream structure;

FIG. 20 illustrates different types of split regions in accordance with embodiments of the present disclosure;

FIG. 21 illustrates overlapping is applied to the region boundary in accordance with embodiments of the present disclosure;

FIG. 22 illustrates shifted regions in accordance with embodiments of the present disclosure;

FIG. 23 illustrates an independent region-based coding in accordance with embodiments of the present disclosure;

FIG. 24 illustrates a flag used to control region split mechanism in accordance with embodiments of the present disclosure;

FIG. 25 illustrates two example grids in accordance with embodiments of the present disclosure;

FIG. 26 illustrates latent tiles in synthesis transform;

FIG. 27 illustrates an example of hyper decoder;

FIG. 28 illustrates an example of applying overlapping on partitions in accordance with embodiments of the present disclosure;

FIG. 29 illustrates an example of applying padding on partitions in accordance with embodiments of the present disclosure;

FIG. 30 illustrates an example of applying both padding and overlapping on partitions in accordance with embodiments of the present disclosure;

FIG. 31 illustrates a flowchart of a method for visual data processing in accordance with embodiments of the present disclosure; and

FIG. 32 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

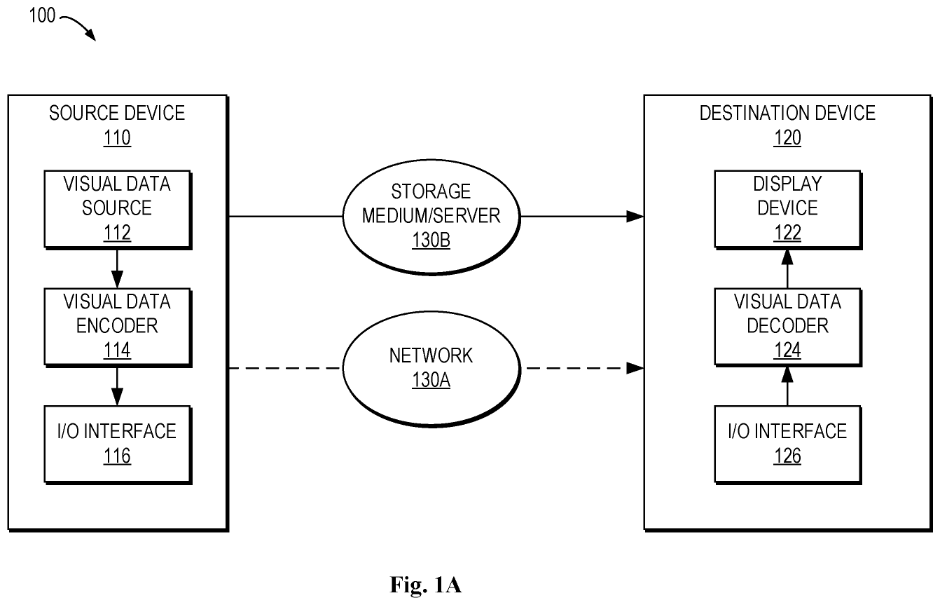

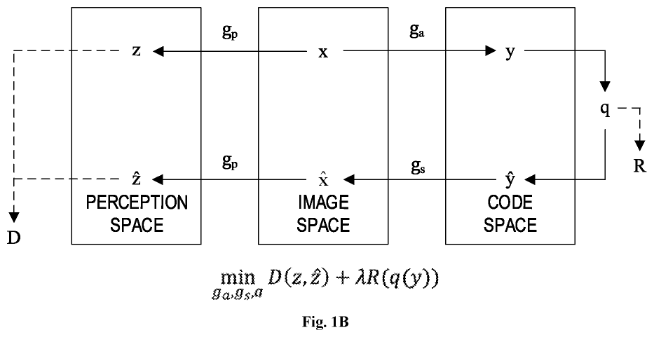

FIG. 1A is a block diagram that illustrates an example visual data coding system 100 that may utilize the techniques of this disclosure. As shown, the visual data coding system 100 may include a source device 110 and a destination device 120. The source device 110 can be also referred to as a visual data encoding device, and the destination device 120 can be also referred to as a visual data decoding device. In operation, the source device 110 can be configured to generate encoded visual data and the destination device 120 can be configured to decode the encoded visual data generated by the source device 110. The source device 110 may include a visual data source 112, a visual data encoder 114, and an input/output (I/O) interface 116.

The visual data source 112 may include a source such as a visual data capture device. Examples of the visual data capture device include, but are not limited to, an interface to receive visual data from a visual data provider, a computer graphics system for generating visual data, and/or a combination thereof.

The visual data may comprise one or more pictures of a video or one or more images. The visual data encoder 114 encodes the visual data from the visual data source 112 to generate a bitstream. The bitstream may include a sequence of bits that form a coded representation of the visual data. The bitstream may include coded pictures and associated visual data. The coded picture is a coded representation of a picture. The associated visual data may include sequence parameter sets, picture parameter sets, and other syntax structures. The I/O interface 116 may include a modulator/demodulator and/or a transmitter. The encoded visual data may be transmitted directly to destination device 120 via the I/O interface 116 through the network 130A. The encoded visual data may also be stored onto a storage medium/server 130B for access by destination device 120.

The destination device 120 may include an I/O interface 126, a visual data decoder 124, and a display device 122. The I/O interface 126 may include a receiver and/or a modem. The I/O interface 126 may acquire encoded visual data from the source device 110 or the storage medium/server 130B. The visual data decoder 124 may decode the encoded visual data. The display device 122 may display the decoded visual data to a user. The display device 122 may be integrated with the destination device 120, or may be external to the destination device 120 which is configured to interface with an external display device.

The visual data encoder 114 and the visual data decoder 124 may operate according to a visual data coding standard, such as video coding standard or still picture coding standard and other current and/or further standards.

Some exemplary embodiments of the present disclosure will be described in detailed hereinafter. It should be understood that section headings are used in the present document to facilitate ease of understanding and do not limit the embodiments disclosed in a section to only that section. Furthermore, while certain embodiments are described with reference to Versatile Video Coding or other specific visual data codecs, the disclosed techniques are applicable to other coding technologies also. Furthermore, while some embodiments describe coding steps in detail, it will be understood that corresponding steps decoding that undo the coding will be implemented by a decoder. Furthermore, the term visual data processing encompasses visual data coding or compression, visual data decoding or decompression and visual data transcoding in which visual data are represented from one compressed format into another compressed format or at a different compressed bitrate.

### 1. Brief Summary

This disclosure is related to neural network (NN)-based image and video coding. Specifically, it is related to support of regional accessibility, wherein regional accessibility refers to the capability of correctly decoding only a regional part of an image (also referred to as a picture) or a video. The ideas may be applied individually or in various combinations, for image and/or video coding methods and specifications.

### 2. Introduction

The past decade has witnessed the rapid development of deep learning in a variety of areas, especially in computer vision and image processing. Inspired from the great success of deep learning technology to computer vision areas, many researchers have shifted their attention from conventional image/video compression techniques to neural image/video compression technologies. Neural network was invented originally with the interdisciplinary research of neuroscience and mathematics. It has shown strong capabilities in the context of non-linear transform and classification. Neural network-based image/video compression technology has gained significant progress during the past half decade. It is reported that the latest neural network-based image compression algorithm achieves comparable R-D performance with Versatile Video Coding (VVC), the latest video coding standard developed by Joint Video Experts Team (JVET) with experts from MPEG and VCEG. With the performance of neural image compression continually being improved, neural network-based video compression has become an actively developing research area. However, neural network-based video coding still remains in its infancy due to the inherent difficulty of the problem.

### 1.1 Image/Video Compression

Image/video compression (also referred to as image/video coding) usually refers to the computing technology that compresses image/video into binary code to facilitate storage and transmission. The binary codes may or may not support losslessly reconstructing the original image/video, termed lossless compression and lossy compression. Most of the efforts are devoted to lossy compression since lossless reconstruction is not necessary in most scenarios. Usually the performance of image/video compression algorithms is evaluated from two aspects, i.e. compression ratio and reconstruction quality. Compression ratio is directly related to the number of binary codes, the less the better; Reconstruction quality is measured by comparing the reconstructed image/video with the original image/video, the higher the better.

Image/video compression techniques can be divided into two branches, the classical video coding methods and the neural-network-based video compression methods. Classical video coding schemes adopt transform-based solutions, in which researchers have exploited statistical dependency in the latent variables (e.g., DCT or wavelet coefficients) by carefully hand-engineering entropy codes modeling the dependencies in the quantized regime. Neural network-based video compression is in two flavors, neural network-based coding tools and end-to-end neural network-based video compression. The former is embedded into existing classical video codecs as coding tools and only serves as part of the framework, while the latter is a separate framework developed based on neural networks without depending on classical video codecs.

In the last three decades, a series of classical video coding standards have been developed to accommodate the increasing visual content. The international standardization organizations ISO/IEC has two expert groups namely Joint Photographic Experts Group (JPEG) and Moving Picture Experts Group (MPEG), and ITU-T also has its own Video Coding Experts Group (VCEG) which is for standardization of image/video coding technology. The influential video coding standards published by these organizations include JPEG, JPEG 2000, H.262, H.264/AVC and H.265/HEVC. After H.265/HEVC, the Joint Video Experts Team (JVET) formed by MPEG and VCEG has been working on a new video coding standard Versatile Video Coding (VVC). The first version of VVC was released in July 2020. An average of 50% bitrate reduction is reported by VVC under the same visual quality compared with HEVC.

Neural network-based image/video compression is not a new invention since there were a number of researchers working on neural network-based image coding. But the network architectures were relatively shallow, and the performance was not satisfactory. Benefit from the abundance of data and the support of powerful computing resources, neural network-based methods are better exploited in a variety of applications. At present, neural network-based image/video compression has shown promising improvements, confirmed its feasibility. Nevertheless, this technology is still far from mature and a lot of challenges need to be addressed.

### 1.2 Neural Networks

Neural networks, also known as artificial neural networks (ANN), are the computational models used in machine learning technology which are usually composed of multiple processing layers and each layer is composed of multiple simple but non-linear basic computational units. One benefit of such deep networks is believed to be the capacity for processing data with multiple levels of abstraction and converting data into different kinds of representations. Note that these representations are not manually designed; instead, the deep network including the processing layers is learned from massive data using a general machine learning procedure. Deep learning eliminates the necessity of handcrafted representations, and thus is regarded useful especially for processing natively unstructured data, such as acoustic and visual signal, whilst processing such data has been a longstanding difficulty in the artificial intelligence field.

### 1.3 Neural Networks for Image Compression

Existing neural networks for image compression methods can be classified in two categories, i.e., pixel probability modeling and auto-encoder. The former one belongs to the predictive coding strategy, while the latter one is the transform-based solution. Sometimes, these two methods are combined together in literature.

### 1.3.1 Pixel Probability Modeling

According to Shannon's information theory, the optimal method for lossless coding can reach the minimal coding rate −log₂ p(x) where p(x) is the probability of symbol x. A number of lossless coding methods were developed in literature and among them arithmetic coding is believed to be among the optimal ones. Given a probability distribution p(x), arithmetic coding ensures that the coding rate to be as close as possible to its theoretical limit −log₂ p(x) without considering the rounding error. Therefore, the remaining problem is to how to determine the probability, which is however very challenging for natural image/video due to the curse of dimensionality.

Following the predictive coding strategy, one way to model p(x) is to predict pixel probabilities one by one in a raster scan order based on previous observations, where x is an image.

p(x)=p(x₁)p(x₂|x₁) . . . p(xᵢ|x₁, . . . ,xᵢ₋₁) . . . p(x_{m×n}|x₁, . . . ,x_{m×n-1}) (1)

where m and n are the height and width of the image, respectively. The previous observation is also known as the context of the current pixel. When the image is large, it can be difficult to estimate the conditional probability, thereby a simplified method is to limit the range of its context.

p(x)=p(x₁)p(x₂|x₁) . . . p(xᵢ|xᵢ₋ₖ, . . . ,xᵢ₋₁) . . . p(x_{m×n}|x_{m×n-k}, . . . ,x_{m×n-1}) (2)

where k is a pre-defined constant controlling the range of the context.

It should be noted that the condition may also take the sample values of other color components into consideration. For example, when coding the RGB color component, R sample is dependent on previously coded pixels (including R/G/B samples), the current G sample may be coded according to previously coded pixels and the current R sample, while for coding the current B sample, the previously coded pixels and the current R and G samples may also be taken into consideration.

Neural networks were originally introduced for computer vision tasks and have been proven to be effective in regression and classification problems. Therefore, it has been proposed using neural networks to estimate the probability of p(xᵢ) given its context x₁, x₂, . . . , xᵢ₋₁.

Most of the methods directly model the probability distribution in the pixel domain. Some researchers also attempt to model the probability distribution as a conditional one upon explicit or latent representations. That being said, it may be estimated that

$$p ( x \vert h ) = {\prod }_{i = 1}^{m \times n} p ( {x}_{i} \vert {x}_{1} , … , {x}_{i - 1} , h ) \qquad ( 3 )$$

where h is the additional condition and p(x)=p(h)p(x|h), meaning the modeling is split into an unconditional one and a conditional one. The additional condition can be image label information or high-level representations.

### 1.3.2 Auto-Encoder

Auto-encoder originates from the well-known work proposed by Hinton and Salakhutdinov. The method is trained for dimensionality reduction and consists of two parts: encoding and decoding. The encoding part converts the high-dimension input signal to low-dimension representations, typically with reduced spatial size but a greater number of channels. The decoding part attempts to recover the high-dimension input from the low-dimension representation. Auto-encoder enables automated learning of representations and eliminates the need of hand-crafted features, which is also believed to be one of the most important advantages of neural networks. FIG. 1B illustrates a typical transform coding scheme. The original image x is transformed by the analysis network gₐ to achieve the latent representation y. The latent representation y is quantized and compressed into bits. The number of bits R is used to measure the coding rate. The quantized latent representation ŷ is then inversely transformed by a synthesis network gₛ to obtain the reconstructed image \hat{x}. The distortion is calculated in a perceptual space by transforming x and \hat{x} with the function gₚ.

It is intuitive to apply auto-encoder network to lossy image compression. It is only needed to encode the learned latent representation from the well-trained neural networks. However, it is not trivial to adapt auto-encoder to image compression since the original auto-encoder is not optimized for compression thereby not efficient by directly using a trained auto-encoder. In addition, there exist other major challenges: First, the low-dimension representation should be quantized before being encoded, but the quantization is not differentiable, which is required in backpropagation while training the neural networks. Second, the objective under compression scenario is different since both the distortion and the rate need to be take into consideration. Estimating the rate is challenging. Third, a practical image coding scheme needs to support variable rate, scalability, encoding/decoding speed, interoperability. In response to these challenges, a number of researchers have been actively contributing to this area.

The prototype auto-encoder for image compression is in FIG. 1B, which can be regarded as a transform coding strategy. The original image x is transformed with the analysis network y=gₐ(x), where y is the latent representation which will be quantized and coded. The synthesis network will inversely transform the quantized latent representation ŷ back to obtain the reconstructed image \hat{x}=gₛ(ŷ). The framework is trained with the rate-distortion loss function, i.e., [symbol] =D+ΔR, where D is the distortion between x and \hat{x}, R is the rate calculated or estimated from the quantized representation ŷ, and λ is the Lagrange multiplier. It should be noted that D can be calculated in either pixel domain or perceptual domain. All existing research works follow this prototype and the difference might only be the network structure or loss function.

### 1.3.3 Hyper Prior Model

In the transform coding approach to image compression, the encoder subnetwork (section 2.3.2) transforms the image vector x using a parametric analysis transform gₐ(x, Ø_{g}) into a latent representation y, which is then quantized to form ŷ. Because ŷ is discrete-valued, it can be losslessly compressed using entropy coding techniques such as arithmetic coding and transmitted as a sequence of bits.

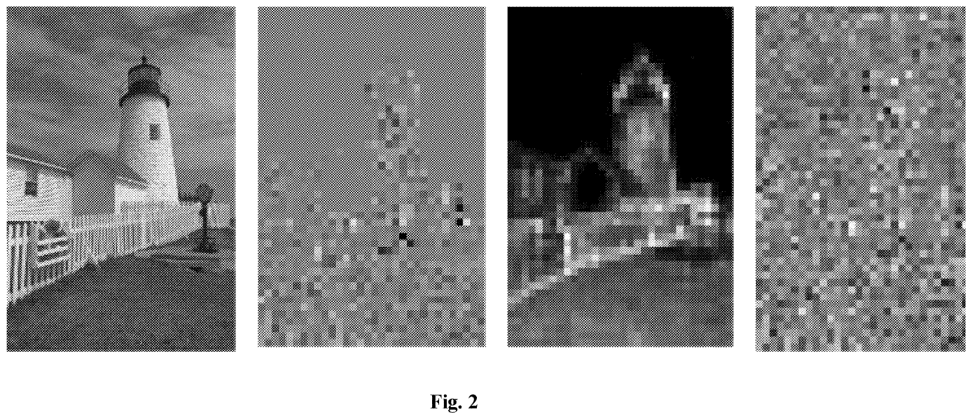

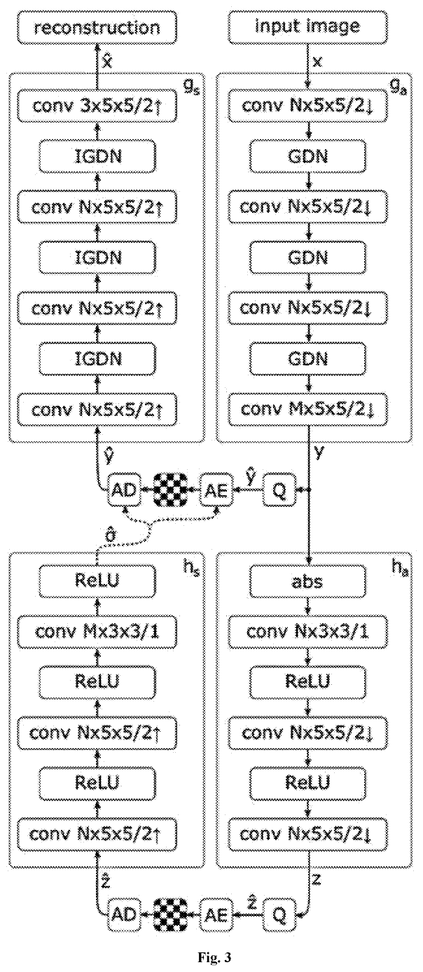

As evident from the middle left and middle right image of FIG. 2, there are significant spatial dependencies among the elements of ŷ. Notably, their scales (middle right image) appear to be coupled spatially. An additional set of random variables \hat{z} can be introduced to capture the spatial dependencies and to further reduce the redundancies. In this case the image compression network is depicted in FIG. 3.

In FIG. 3, the left hand of the models is the encoder gₐ and decoder gₛ (explained in section 2.3.2). The right-hand side is the additional hyper encoder hₐ and hyper decoder hₛ networks that are used to obtain \hat{z}. In this architecture the encoder subjects the input image x to gₐ, yielding the responses y with spatially varying standard deviations. The responses y are fed into hₐ, summarizing the distribution of standard deviations in z. z is then quantized (\hat{z}), compressed, and transmitted as side information. The encoder then uses the quantized vector \hat{z} to estimate σ, the spatial distribution of standard deviations, and uses it to compress and transmit the quantized image representation ŷ. The decoder first recovers \hat{z} from the compressed signal. It then uses hₛ to obtain σ, which provides it with the correct probability estimates to successfully recover ŷ as well. It then feeds ŷ into gₛ to obtain the reconstructed image.

When the hyper encoder and hyper decoder are added to the image compression network, the spatial redundancies of the quantized latent ŷ are reduced. The rightmost image in FIG. 2 correspond to the quantized latent when hyper encoder/decoder are used. Compared to middle right image, the spatial redundancies are significantly reduced, as the samples of the quantized latent are less correlated.

In FIG. 2: Left: an image from the Kodak dataset. Middle left: visualization of a latent representation y of that image. Middle right: standard deviations σ of the latent. Right: latents y after the hyper prior (hyper encoder and decoder) network is introduced.

FIG. 3 illustrates Network architecture of an autoencoder implementing the hyperprior model. The left side shows an image autoencoder network, the right side corresponds to the hyperprior subnetwork. The analysis and synthesis transforms are denoted as gₐ and gₐ. Q represents quantization, and AE, AD represent arithmetic encoder and arithmetic decoder, respectively. The hyperprior model consists of two subnetworks, hyper encoder (denoted with hₐ) and hyper decoder (denoted with hₛ). The hyper prior model generates a quantized hyper latent (\hat{z}) which comprises information about the probability distribution of the samples of the quantized latent \grave{y}. \hat{z} is included in the bitsteam and transmitted to the receiver (decoder) along with ŷ.

### 1.3.4 Context Model

Although the hyper prior model improves the modelling of the probability distribution of the quantized latent y, additional improvement can be obtained by utilizing an autoregressive model that predicts quantized latents from their causal context (Context Model).

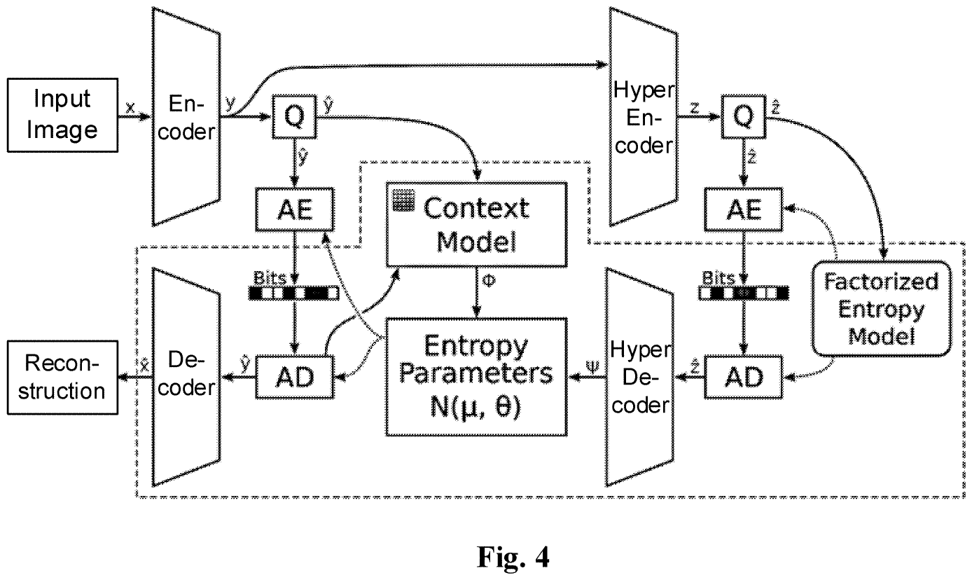

The term auto-regressive means that the output of a process is later used as input to it. For example the context model subnetwork generates one sample of a latent, which is later used as input to obtain the next sample. FIG. 4 is a schematic diagram illustrating an example combined model configured to jointly optimize a context model along with a hyperprior and the autoencoder. The following Table 1 illustrates meaning of different symbols.

TABLE 1
Illustration of symbols

| Component | Symbol |
|---|---|
| Input Image | x |
| Encoder | f(x; θₑ) |
| Latents | y |
| Latents (quantized) | ŷ |
| Decoder | g(ŷ; θ_{d}) |
| Hyper Encoder | fₕ(y; θₕₑ) |
| Hyper-Latents | z |
| Hyper-Latents (quantized) | \hat{z} |
| Hyper Decoder | gₕ(\hat{z}; θ_{hd}) |
| Context Model | g_{cm}(y_{<i}; θ_{cm}) |
| Entropy Parameters | gₑₚ(•; θₑₚ) |
| Reconstruction | \hat{x} |

A joint architecture can be utilized where both hyper prior model subnetwork (hyper encoder and hyper decoder) and a context model subnetwork are utilized. The hyper prior and the context model are combined to learn a probabilistic model over quantized latents ŷ, which is then used for entropy coding. As depicted in FIG. 4, the outputs of context subnetwork and hyper decoder subnetwork are combined by the subnetwork called Entropy Parameters, which generates the mean μ and scale (or variance) σ parameters for a Gaussian probability model. The gaussian probability model is then used to encode the samples of the quantized latents into bitstream with the help of the arithmetic encoder (AE) module. In the decoder the gaussian probability model is utilized to obtain the quantized latents ŷ from the bitstream by arithmetic decoder (AD) module.

FIG. 4 illustrates the combined model jointly optimizes an autoregressive component that estimates the probability distributions of latents from their causal context (Context Model) along with a hyperprior and the underlying autoencoder. Real-valued latent representations are quantized (Q) to create quantized latents (ŷ) and quantized hyper-latents (\hat{z}), which are compressed into a bitstream using an arithmetic encoder (AE) and decompressed by an arithmetic decoder (AD). The highlighted region corresponds to the components that are executed by the receiver (i.e. a decoder) to recover an image from a compressed bitstream.

Typically the latent samples are modeled as gaussian distribution or gaussian mixture models (not limited to). According to FIG. 4, the context model and hyper prior are jointly used to estimate the probability distribution of the latent samples. Since a gaussian distribution can be defined by a mean and a variance (aka sigma or scale), the joint model is used to estimate the mean and variance (denoted as μ and σ).

### 1.3.5 Gained Variational Autoencoders (G-VAE)

Typically, neural network-based image/video compression methodologies need to train multiple models to adapt to different rates. Gained variational autoencoders (G-VAE) is the variational autoencoder with a pair of gain units, which is designed to achieve continuously variable rate adaptation using a single model. It comprises of a pair of gain units, which are typically inserted to the output of encoder and input of decoder. The output of the encoder is defined as the latent representation y∈R^{c*h*w}, where c, h, w represent the number of channels, the height and width of the latent representation. Each channel of the latent representation is denoted as y₍ᵢ₎∈R^{h*w}, where i=0,1, . . . , c−1. A pair of gain units include a gain matrix M∈R^{c*n} and an inverse gain matrix, where n is the number of gain vectors. The gain vector can be denoted as mₛ={αₛ₍₀₎, αₛ₍₁₎, . . . , α_{s(c-1)}}, αₛ₍ᵢ₎∈R where s denotes the index of the gain vectors in the gain matrix.

The motivation of gain matrix is similar to the quantization table in JPEG by controlling the quantization loss based on the characteristics of different channels. To apply the gain matrix to the latent representation, each channel is multiplied with the corresponding value in a gain vector.

y̅ₛ=y⊙mₛ

where ⊙ is channel-wise multiplication, i.e., y̅ₛ₍ᵢ₎=y₍ᵢ₎×αₛ₍ᵢ₎, and αₛ₍ᵢ₎ is the i-th gain value in the gain vector mₛ. The inverse gain matrix used at the decoder side can be denoted as M′∈R^{c*n}, which consists of n inverse gain vectors, i.e., M′={δₛ₍₀₎, δₛ₍₁₎, . . . , δ_{s(c-1)}}, δₛ₍ᵢ₎∈R. The inverse gain process is expressed as:

y̅ₛ=y⊙mₛ

where ŷ is the decoded quantized latent representation and yₛ′ is the inversely gained quantized latent representation, which will be fed into the synthesis network.

To achieve continuous variable rate adjustment, interpolation is used between vectors. Given two pairs of gain vectors {mₜ, m′ₜ} and {mᵣ, m′ᵣ}, the interpolated gain vector can be obtained via the following equations.

mᵥ=[(mᵣ)^{l}·(mₜ)^{1-l}]

m′ᵥ=[(m′ᵣ)^{l}·(m′ₜ)^{1-l}]

where l∈R is an interpolation coefficient, which controls the corresponding bit rate of the generated gain vector pair. Since l is a real number, an arbitrary bit rate between the given two gain vector pairs can be achieved.

### 1.3.6 the Encoding Process Using Joint Auto-Regressive Hyper Prior Model

The FIG. 4. corresponds to the state of the art compression method. In this section and the next, the encoding and decoding processes will be described separately.

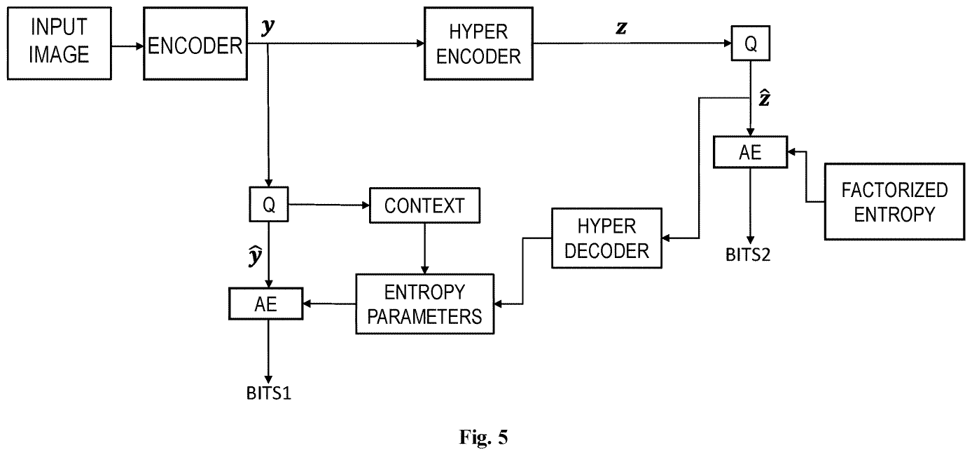

The FIG. 5 depicts the encoding process. The input image is first processed with an encoder subnetwork. The encoder transforms the input image into a transformed representation called latent, denoted by y. y is then input to a quantizer block, denoted by Q, to obtain the quantized latent (ŷ). ŷ is then converted to a bitstream (bits1) using an arithmetic encoding module (denoted AE). The arithmetic encoding block converts each sample of the ŷ into a bitstream (bits1) one by one, in a sequential order.

The modules hyper encoder, context, hyper decoder, and entropy parameters subnetworks are used to estimate the probability distributions of the samples of the quantized latent ŷ. the latent y is input to hyper encoder, which outputs the hyper latent (denoted by z). The hyper latent is then quantized (\hat{z}) and a second bitstream (bits2) is generated using arithmetic encoding (AE) module. The factorized entropy module generates the probability distribution, that is used to encode the quantized hyper latent into bitstream. The quantized hyper latent includes information about the probability distribution of the quantized latent (ŷ).

The Entropy Parameters subnetwork generates the probability distribution estimations, that are used to encode the quantized latent ŷ. The information that is generated by the Entropy Parameters typically include a mean u and scale (or variance) σ parameters, that are together used to obtain a gaussian probability distribution. A gaussian distribution of a random variable x is defined as f(x)=1/σ\sqrt{2π}e^{-1/2(x-μ/σ)}^{²} wherein the parameter μ is the mean or expectation of the distribution (and also its median and mode), while the parameter σ is its standard deviation (or variance, or scale). In order to define a gaussian distribution, the mean and the variance need to be determined. In an existing design, the entropy parameters module are used to estimate the mean and the variance values.

The subnetwork hyper decoder generates part of the information that is used by the entropy parameters subnetwork, the other part of the information is generated by the autoregressive module called context module. The context module generates information about the probability distribution of a sample of the quantized latent, using the samples that are already encoded by the arithmetic encoding (AE) module. The quantized latent ŷ is typically a matrix composed of many samples. The samples can be indicated using indices, such as ŷ[i,j,k] or ŷ[i,j] depending on the dimensions of the matrix ŷ. The samples ŷ[i,j] are encoded by AE one by one, typically using a raster scan order. In a raster scan order the rows of a matrix are processed from top to bottom, wherein the samples in a row are processed from left to right. In such a scenario (wherein the raster scan order is used by the AE to encode the samples into bitstream), the context module generates the information pertaining to a sample ŷ[i,j], using the samples encoded before, in raster scan order. The information generated by the context module and the hyper decoder are combined by the entropy parameters module to generate the probability distributions that are used to encode the quantized latent ŷ into bitstream (bits1).

Finally the first and the second bitstream are transmitted to the decoder as result of the encoding process. It is noted that the other names can be used for the modules described above.

In the above description, the all of the elements in FIG. 5 are collectively called encoder. The analysis transform that converts the input image into latent representation is also called an encoder (or auto-encoder).

### 1.3.7 the Decoding Process Using Joint Auto-Regressive Hyper Prior Model

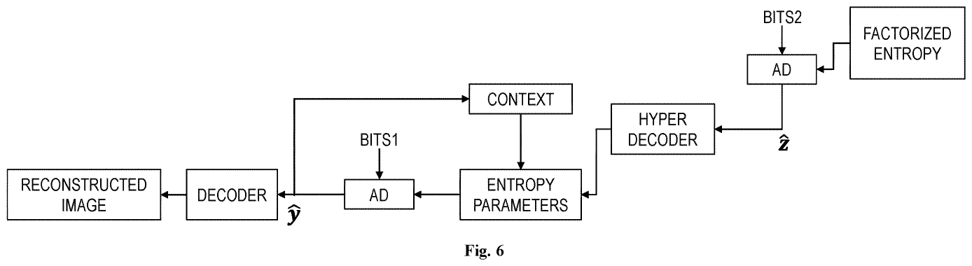

The FIG. 6 depicts the decoding process separately.

In the decoding process, the decoder first receives the first bitstream (bits1) and the second bitstream (bits2) that are generated by a corresponding encoder. The bits2 is first decoded by the arithmetic decoding (AD) module by utilizing the probability distributions generated by the factorized entropy subnetwork. The factorized entropy module typically generates the probability distributions using a predetermined template, for example using predetermined mean and variance values in the case of gaussian distribution. The output of the arithmetic decoding process of the bits2 is \hat{z}, which is the quantized hyper latent. The AD process reverts to AE process that was applied in the encoder. The processes of AE and AD are lossless, meaning that the quantized hyper latent \hat{z} that was generated by the encoder can be reconstructed at the decoder without any change.

After obtaining of \hat{z}, it is processed by the hyper decoder, whose output is fed to entropy parameters module. The three subnetworks, context, hyper decoder and entropy parameters that are employed in the decoder are identical to the ones in the encoder. Therefore the exact same probability distributions can be obtained in the decoder (as in encoder), which is essential for reconstructing the quantized latent ŷ without any loss. As a result the identical version of the quantized latent ŷ that was obtained in the encoder can be obtained in the decoder. After the probability distributions (e.g. the mean and variance parameters) are obtained by the entropy parameters subnetwork, the arithmetic decoding module decodes the samples of the quantized latent one by one from the bitstream bits1. From a practical standpoint, autoregressive model (the context model) is inherently serial, and therefore cannot be sped up using techniques such as parallelization.

Finally the fully reconstructed quantized latent ŷ is input to the synthesis transform (denoted as decoder in FIG. 6) module to obtain the reconstructed image.

In the above description, the all of the elements in FIG. 6 are collectively called decoder. The synthesis transform that converts the quantized latent into reconstructed image is also called a decoder (or auto-decoder).

### 1.4 Neural Networks for Video Compression

Similar to conventional video coding technologies, neural image compression serves as the foundation of intra compression in neural network-based video compression, thus development of neural network-based video compression technology comes later than neural network-based image compression but needs far more efforts to solve the challenges due to its complexity. Starting from 2017, a few researchers have been working on neural network-based video compression schemes. Compared with image compression, video compression needs efficient methods to remove inter-picture redundancy. Inter-picture prediction is then a crucial step in these works. Motion estimation and compensation is widely adopted but is not implemented by trained neural networks until recently.

Studies on neural network-based video compression can be divided into two categories according to the targeted scenarios: random access and the low-latency. In random access case, it requires the decoding can be started from any point of the sequence, typically divides the entire sequence into multiple individual segments and each segment can be decoded independently. In low-latency case, it aims at reducing decoding time thereby usually merely temporally previous frames can be used as reference frames to decode subsequent frames.

### 1.5 Preliminaries

Almost all the natural image/video is in digital format. A grayscale digital image can be represented by x∈ [symbol] ^{m×n}, where [symbol] is the set of values of a pixel, m is the image height and n is the image width. For example, [symbol] ={0, 1,2, . . . ,255} is a common setting and in this case | [symbol] |=256=2⁸, thus the pixel can be represented by an 8-bit integer. An uncompressed grayscale digital image has 8 bits-per-pixel (bpp), while compressed bits are definitely less.

A color image is typically represented in multiple channels to record the color information. For example, in the RGB color space an image can be denoted by x∈ [symbol] ^{m×n×3} with three separate channels storing Red, Green and Blue information. Similar to the 8-bit grayscale image, an uncompressed 8-bit RGB image has 24 bpp. Digital images/videos can be represented in different color spaces. The neural network-based video compression schemes are mostly developed in RGB color space while the traditional codecs typically use YUV color space to represent the video sequences. In YUV color space, an image is decomposed into three channels, namely Y, Cb and Cr, where Y is the luminance component and Cb/Cr are the chroma components. The benefits come from that Cb and Cr are typically down sampled to achieve pre-compression since human vision system is less sensitive to chroma components.

A color video sequence is composed of multiple color images, called frames, to record scenes at different timestamps. For example, in the RGB color space, a color video can be denoted by X={x₀, x₁, . . . , xₜ, . . . , x_{T-1}} where T is the number of frames in this video sequence, x∈ [symbol] ^{m×n}. If m=1080, n=1920, | [symbol] |=2⁸, and the video has 50 frames-per-second (fps), then the data rate of this uncompressed video is 1920×1080×8×3×50=2,488,320,000 bits-per-second (bps), about 2.32 Gbps, which needs a lot storage thereby definitely needs to be compressed before transmission over the internet.

Usually the lossless methods can achieve compression ratio of about 1.5 to 3 for natural images, which is clearly below requirement. Therefore, lossy compression is developed to achieve further compression ratio, but at the cost of incurred distortion. The distortion can be measured by calculating the average squared difference between the original image and the reconstructed image, i.e., mean-squared-error (MSE). For a grayscale image, MSE can be calculated with the following equation.

$$M S E = \frac{{‖ x - \hat{x} ‖}^{2}}{m \times n} \qquad ( 4 )$$

Accordingly, the quality of the reconstructed image compared with the original image can be measured by peak signal-to-noise ratio (PSNR):

$$P S N R = 10 \times {log}_{10} \frac{{( max ( 𝔻 ) )}^{2}}{M S E} \qquad ( 5 )$$

where max( [symbol] ) is the maximal value in D, e.g., 255 for 8-bit grayscale images. There are other quality evaluation metrics such as structural similarity (SSIM) and multi-scale SSIM (MS-SSIM).

To compare different lossless compression schemes, it is sufficient to compare either the compression ratio given the resulting rate or vice versa. However, to compare different lossy compression methods, it has to take into account both the rate and reconstructed quality. For example, to calculate the relative rates at several different quality levels, and then to average the rates, is a commonly adopted method; the average relative rate is known as Bjontegaard's delta-rate (BD-rate). There are other important aspects to evaluate image/video coding schemes, including encoding/decoding complexity, scalability, robustness, and so on.

### 1.6 Separate Processing of Luma and Chroma Components of an Image

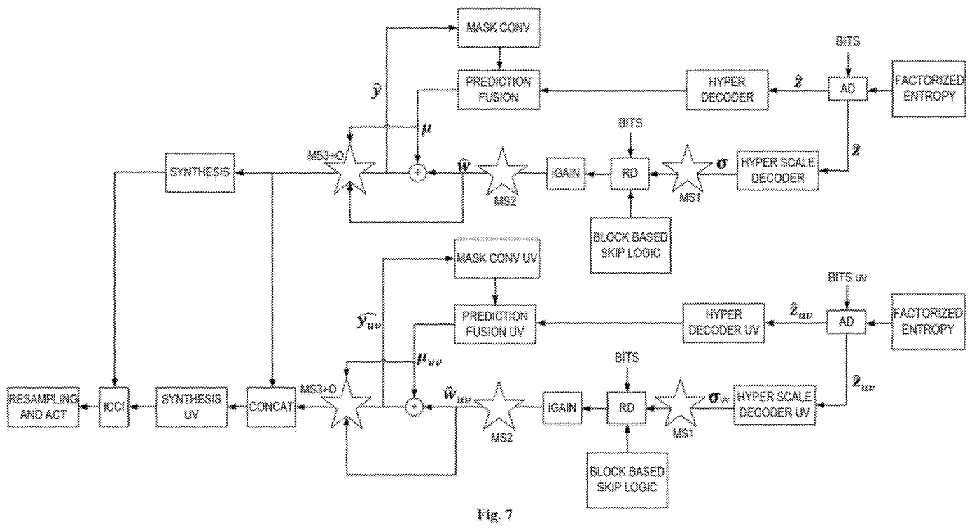

FIG. 7 illustrates the decoding process according to some example embodiments of the present disclosure. According to one implementation, the luma and chroma components of an image can be decoded using separate subnetworks. In FIG. 7, the luma component of the image is processed by the subnetwoks “Synthesis”, “Prediction fusion”, “Mask Conv”, “Hyper Decoder”, “Hyper scale decoder” etc. Whereas the chroma components are processed by the subnetworks: “Synthesis UV”, “Prediction fusion UV”, “Mask Conv UV”, “Hyper Decoder UV”, “Hyper scale decoder UV” etc.

A benefit of the above separate processing is that the computational complexity of the processing of an image is reduced by application of separate processing. Typically in neural network based image and video decoding, the computational complexity is proportional to the square of the number of feature maps. If the number of total feature maps is equal to 192 for example, computational complexity will be proportional to 192×192. On the other hand if the feature maps are divided into 128 for luma and 64 for chroma (in the case of separate processing), the computational complexity is proportional to 128×128+64×64, which corresponds to a reduction in complexity by 45%. Typically the separate processing of luma and chroma components of an image does not result in a prohibitive reduction in performance, as the correlation between the luma and chroma components are typically very small.

The processing (Decoding process) in FIG. 7 can be explained below:
1. Firstly, the factorized entropy model is used to decode the quantized latents for luma and chroma, i.e., \hat{z} and \hat{z}ᵤᵥ in FIG. 7.
2. The probability parameters (e.g. variance) generated by the second network are used to generate a quantized residual latent by performing the arithmetic decoding process.
3. The quantized residual latent is inversely gained with the inverse gain unit (iGain) as shown in orange color in FIG. 7. The outputs of the inverse gain units are denoted as ŵ and ŵᵤᵥ for luma and chroma components, respectively.
4. For the luma component, the following steps are performed in a loop until all elements of ŷ are obtained:
   a. A first subnetwork is used to estimate a mean value parameter of a quantized latent (ŷ), using the already obtained samples of ŷ.
   b. The quantized residual latent ŵ and the mean value are used to obtain the next element of ŷ.
5. After all of the samples of ŷ are obtained, a synthesis transform can be applied to obtain the reconstructed image.
6. For chroma component, step 4 and 5 are the same but with a separate set of networks.
7. The decoded luma component is used as additional information to obtain the chroma component. Specifically, the Inter Channel Correlation Information filter sub-network (ICCI) is used for chroma component restoration. The luma is fed into the ICCI sub-network as additional information to assist the chroma component decoding.
8. Adaptive color transform (ACT) is performed after the luma and chroma components are reconstructed. The module named ICCI is a neural-network based postprocessing module. The example embodiments of the present disclosure are not limited to the UCCI subnetwork, any other neural network based postprocessing module might also be used.

An exemplary implementation of some example embodiments of the present disclosure is depicted in FIG. 7 (the decoding process). The framework comprises two branches for luma and chroma components respectively. In each of the branch, the first subnetwork comprises the context, prediction and optionally the hyper decoder modules. The second network comprises the hyper scale decoder module. The quantized hyper latent are \hat{z} and \hat{z}ᵤᵥ. The arithmetic decoding process generates the quantized residual latents, which are further fed into the iGain units to obtain the gained quantized residual latents ŵ and ŵᵤᵥ.

After the residual latent is obtained, a recursive prediction operation is performed to obtain the latent ŷ and ŷᵤᵥ. The following steps describe how to obtain the samples of latent ŷ[:, i, j], and the chroma component is processed in the same way but with different networks.
1. An autoregressive context module is used to generate first input of a prediction module using the samples ŷ[:, m, n] where the (m, n) pair are the indices of the samples of the latent that are already obtained.
2. Optionally the second input of the prediction module is obtained by using a hyper decoder and a quantized hyper latent \hat{z}₁.
3. Using the first input and the second input, the prediction module generates the mean value mean[:, i, j].
4. The mean value mean[:, i, j] and the quantized residual latent ŵ[:, i, j] are added together to obtain the latent ŷ[:, i, j].
5. The steps 1-4 are repeated for the next sample.

Whether to and/or how to apply at least one method disclosed in the document may be signaled from the encoder to the decoder, e.g. in the bitstream.

Alternatively, whether to and/or how to apply at least one method disclosed in the document may be determined by the decoder based on coding information, such as dimensions, color format, etc.

Alternative or additionally, the modules named MS1, MS2 or MS3+O (in FIG. 7), might be included in the processing flow. The said modules might perform an operation to their input by multiplying the input with a scalar or adding an adding an additive component to the input to obtain the output. The scalar or the additive component that are used by the said modules might be indicated in a bitstream.

The module named RD or the module named AD in FIG. 7 might be an entropy decoding module. It might be a range decoder or an arithmetic decoder or the like.

The example embodiments of the present disclosure described herein are not limited to the specific combination of the units exemplified in FIG. 7. Some of the modules might be missing and some of the modules might be displaced in processing order. Also additional modules might be included. For example:
1. The ICCI module might be removed. In that case the output of the Synthesis module and the Synthesis UV module might be combined by means of another module, that might be based on neural networks.
2. One or more of the modules named MS1, MS2 or MS3+O might be removed. The core of the proposed solution is not affected by the removing of one or more of the said scaling and adding modules.

In FIG. 7, other operations that are performed during the processing of the luma and chroma components are also indicated using the star symbol. These processes are denoted as MS1, MS2, MS3+O. These processing might be, but not limited to, adaptive quantization, latent sample scaling, and latent sample offsetting operations. For example, in an adaptive quantization process might correspond to scaling of a sample with multiplier before the prediction process, wherein the multiplier is predefined or whose value is indicated in the bitstream. The latent scaling process might correspond to the process where a sample is scaled with a multiplier after the prediction process, wherein the value of the multiplier is either predefined or indicated in the bitstream. The offsetting operation might correspond to adding an additive element to the sample, again wherein the value of the additive element might be indicated in the bitstream or inferred or predetermined.

Another operation might be tiling operation, wherein samples are first tiled (grouped) into overlapping or non-overlapping regions, wherein each region is processed independently. For example the samples corresponding to the luma component might be divided into tiles with a tile height of 20 samples, whereas the chroma components might be divided into tiles with a tile height of 10 samples for processing.

Another operation might be application of wavefront parallel processing. In wavefront parallel processing, a number of samples might be processed in parallel, and the amount of samples that can be processed in parallel might be indicated by a control parameter. The said control parameter might be indicated in the bitstream, be inferred, or can be predetermined. In the case of separate luma and chroma processing, the number of samples that can be processed in parallel might be different, hence different indicators can be signalled in the bitstream to control the operation of luma and chrome processing separately.

### 1.7 Colors Separation and Conditional Coding

In one example the primary and secondary color components of an image are coded separately, using networks with similar architecture, but different number of channels as shown in 8. All boxes with same names are subnetworks with the similar architecture, only input-output tensor size and number of channels are different. Number of channels for primary component is Cₚ=128, for secondary components is Cₛ=64. The vertical arrows (with arrowhead pointing downwards) indicate data flow related to secondary color components coding. Vertical arrows show data exchange between primary and secondary components pipelines.

The input signal to be encoded is notated as x, latent space tensor in bottleneck of variational auto-encoder is y. Subscript “Y” indicates primary component, subscript “UV” is used for concatenated secondary components, there are chroma components.

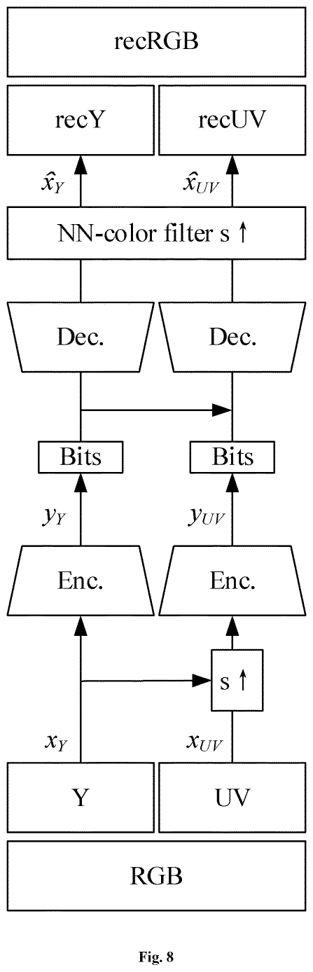

FIG. 8 illustrates learning-based image codec architecture.

First the input image that has RGB color format is converted to primary (Y) and secondary components (UV). The primary component x_{Y} is coded independently from secondary components x_{UV} and the coded picture size is equal to input/decoded picture size. The secondary components are coded conditionally, using x_{Y} as auxiliary information from primary component for encoding x_{UV} and using ŷ_{Y} as a latent tensor with auxiliary information from primary component for decoding ŷ_{UV} reconstruction. The codec structure for primary component and secondary components are almost identical except the number of channels, size of the channels and the several entropy models for transforming latent tensor to bitstream, therefore primary and secondary latent tensor will generate two different bitstream based on two different entropy models. Prior to the encoding x_{Y}, x_{UV} goes through a module which adjusts the sample location by down-sampling (marked as “s↓” on FIG. 1), this essentially means that coded picture size for secondary component is different from the coded picture size for primary component. The scaling factor s is variable, but the default scaling factor is s=2. The size of auxiliary input tensor in conditional coding is adjusted in order the encoder receives primary and secondary components tensor with the same picture size. After reconstruction, the secondary component is rescaled to the original picture size with a neural-network based upsampling filter module (“NN-color filter s↑” on FIG. 1), which outputs secondary components up-sampled with factor s.

The example in FIG. 8 exemplifies an image coding system, where the input image is first transformed into primary (Y) and secondary components (UV). The outputs \hat{x}_{Y}, \hat{x}_{UV} are the reconstructed outputs corresponding to the primary and secondary components. At the and of the processing, \hat{x}_{Y}, \hat{x}_{UV} are converted back to RGB color format. Typically the x_{UV} is downsampled (resized) before processing with the encoding and decoding modules (neural networks). For example the size of the x_{UV} might be reduced by a factor of 50% in each of the vertical and horizontal dimensions. Therefore the processing of the secondary component includes approximately 50%×50%=25% less samples, therefore it is computationally less complex.

### 1.8 Cropping Operation in Neural Network Based Coding

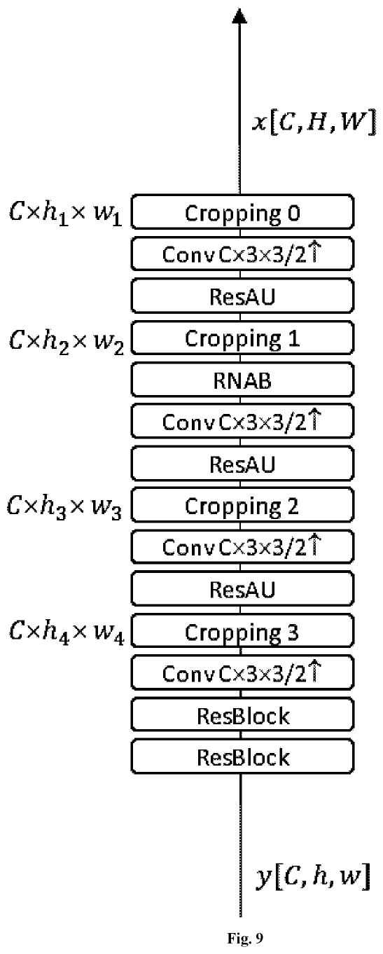

FIG. 9 illustrates synthesis transform example for learning based image coding. The example synthesis transform above includes a sequence of 4 convolutions with up-sampling with stride of 2. The synthesis transform sub-Net is depicted on FIG. 9. The size of the tensor in different parts of synthesis transform before cropping layer is the diagram on FIG. 9.

The cropping layer changes tensor size h_{d}×w_{d} to h_{d-1}×w_{d-1}, where h_{d}=2·ceil(H/2^{d}); w_{d}=2·ceil (W/2^{d}); here d is the depth of proceeding convolution in the codec architecture. For primary component Synthesis Transform receives input tensor with size h×w; h=ceil(H/16); w=ceil(W/16). The output of Synthesis Transform for primary component is 1×h₀×w₀, where h₀=H; h₀=W.

For secondary component Synthesis Transform receives input tensor with size h_{UV}×w_{UV}; h_{UV}=ceil(ceil(H/s)/16); w_{UV}=ceil(ceil(W/s)/16). The output of the Synthesis Transform for primary component is 2×h_{UV0}×w_{UV0}, where h_{UV0}=ceil(H/s); h_{UV0}=ceil(W/s). For secondary components input sizes are h₀=ceil(H/s); w₀=ceil(W/s), where s is the scale factor. The scale factor might be 2 for example, wherein the secondary component is downsampled by a factor of 2.

Based on the above explanation, the operation of the cropping layers depend on the output size H, W and the depth of the cropping layer. The depth of the left-most cropping layer in FIG. 9 is equal to 0. The output of this cropping layer must be equal to H, W (the output size), if the size of the input of this cropping layer is greater than H or W in horizontal or vertical dimension respectively, cropping needs to be performed in that dimension. The second cropping layer counting from left to right has a depth of 1. The output of the second cropping layer must be equal to h₁=2·ceil(H/2¹); w₁=2·ceil(W/2¹), which means if the input of this second cropping layer is greater than h1, w1 in any dimension, than cropping is applied in that dimension. In summary, the operation of cropping layers are controlled by the output size H,W. In one example if H and W are both equal to 16, then the cropping layers do not perform any cropping. On the other hand if H and W are both equal to 17, then all 4 cropping layers are going to perform cropping.

### 1.9 Bitwise Shifting

The bitwise shift operator can be represented using the function bitshift(x, n), where n is an integer number. If n is greater than 0, it corresponds to right-shift operator (>>), which moves the bits of of the input to the right, and the left-shift operator (<<), which moves the bits to the left. In another words the bitshift(x, n) operation corresponds to:

bitshift(x,n)=x*2ⁿ, or

bitshift(x,n)=floor(x*2ⁿ), or

bitshift(x,n)=x//2ⁿ.

The output of the bitshift operation is an integer value. In some implementations, the floor ( ) function might be added to the definition.

Floor (x) is equal to the largest integer less than or equal to x.

The “//” operator or the integer division operator: It is an operation that comprises division and truncation of the result toward zero. For example, 7/4 and −7/−4 are truncated to 1 and −7/4 and 7/−4 are truncated to −1.

rightshift(x,n)=x»n or

leftshift(x,n)=x«n

Equation 3: alternative implementation of the bitshift operator as rightshift or leftshift.
x>>y Arithmetic right shift of a two's complement integer representation of x by y binary digits. This function is defined only for non-negative integer values of y. Bits shifted into the most significant bits (MSBs) as a result of the right shift have a value equal to the MSB of x prior to the shift operation.
x<<y Arithmetic left shift of a two's complement integer representation of x by y binary digits. This function is defined only for non-negative integer values of y. Bits shifted into the least significant bits (LSBs) as a result of the left shift have a value equal to 0.

### 1.10 Convolution Operation

The convolution is a fairly simple operation at heart: you start with a kernel, which is simply a small matrix of weights. This kernel “slides” over the input data, performing an elementwise multiplication with the part of the input it is currently on, and then summing up the results into a single output pixel. In some cases the convolution operation might comprise a “bias”, which is added to the output of the elementwise multiplication operation. The convolution operation might be described by the following mathematical formula. An output out1 can be obtained as:

$$out 1 [ x , y ] = conv 1 ( I ) = {\sum }_{k = 0}^{M} {\sum }_{i = 0}^{N} {\sum }_{j = 0}^{P} w {1}_{k} [ i , j ] \times {I}_{k} [ x + i , y + j ] + K 1$$

wherein w1 are the multiplication factors, K1 is called a bias (an additive term) and Iₖ is the k^{th} input, and N is the kernel size in one direction and P is the kernel size in another direction. The convolution layer might consist of convolution operations wherein more than one output might be generated. Other equivalent depictions of the convolution operation might be found below:

$$out 1 [ x , y ] = conv 1 ( I ) = {\sum }_{k = 0}^{M} {\sum }_{i = 0}^{N} {\sum }_{j = 0}^{P} w 1 [ k , i , j ] \times I [ k , x + i , y + j ] + K 1$$

$$out [ c , x , y ] = conv ( I ) = {\sum }_{k = 0}^{M} {\sum }_{i = 0}^{N} {\sum }_{j = 0}^{P} w [ c , k , i , j ] \times I [ k , x + i , y + j ] + K [ c ]$$

In the above equations “c” indicates the channel number. It is equivalent to output number, out[1,x,y] is one output and out[2,x,y] is a second output. Wherein the k is the input number, I[1, x, y] is one input and I[2, x, y] is a second input.

The w1, or w describe weights of the convolution operation.

### 1.11Leaky_Relu Activation Function

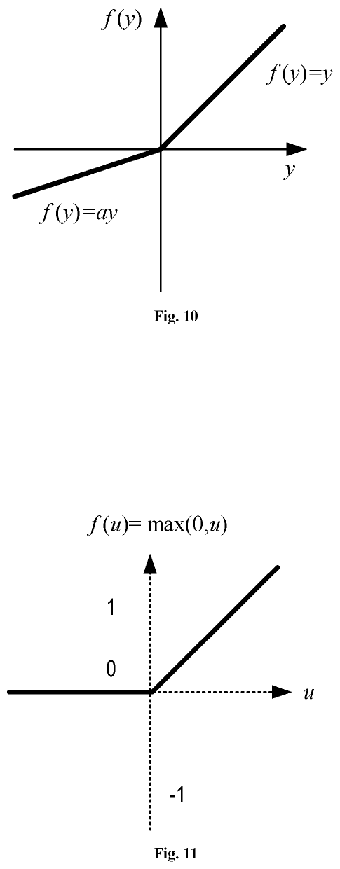

The leaky relu activation function is depicted in FIG. 10. According to the function, if the input is a positive value, the output is equal to the input. If the input (y) is a negative value, the output is equal to a*y. The a is typically (not limited to) a value that is smaller than 1 and greater than 0. Since the multiplier a is smaller than 1, it can be implemented either as a multiplication with a non-integer number, or with a division operation. The multiplier a might be called the negative slope of the leaky relu function.

### 1.12 Relu Activation Function

The relu activation function is depicted in FIG. 11. According to the function, if the input is a positive value, the output is equal to the input. If the input (y) is a negative value, the output is equal to 0.

### 1.13 the JPEG AI Image Coding Standard

The existing design utilizes some NN-based image coding methods described mentioned above. Some of the features are described or summarized below. The numbers in parentheses are section numbers for reference.

### 1. (3.5.20) Padding Layer

padding layer is denoted as Padd(Hᵢₙ, Wᵢₙ, d, s_{d}), where Hᵢₙ, Wᵢₙ are height and width of tensor-input to Analysis transform, s_{d} is stride of proceeding convolution, d is depth of convolution layer in deep learnable encoder. Padding layer receives tensor of size [C, h_{d-1}, w_{d-1}] and outputs tensor of size [C, s_{d}h_{d}, s_{d}w_{d}], where h_{d}=ceil(h_{d-1}/s_{d}); w_{d}=ceil(w_{d-1}/s_{d}), h₀=Hᵢₙ, w₀=Wᵢₙ. By default padding is performed by replication. Different model of padding can be specified (for example, padding by zeros).

### 2.(3.5.22) Cropping Layer

cropping layer is denoted as Crop(Hᵢₙ, Wᵢₙ, d, s_{d}), where Hᵢₙ, Wᵢₙ are height and width of tensor—output to Synthesis transform, s_{d} is stride of proceeding transposed convolution, d is depth of convolution layer in deep learnable reconstruction process. Cropping layer outputs a tensor of size [C, h_{d-1}, w_{d-1}], where h_{d-1}, w_{d-1} defined in Table 2. Note, that h₀=Hᵢₙ, w₀=Wᵢₙ. Cropping is performed by discarding redundant elements.

TABLE 2
Tensor size parameters for primary
and secondary components decoding.

| | Primary | Secondary |
|---|---|---|
| | “Y” | “UV” |
| | component | component |
| Hᵢₙ | H | ceil(H /(3 − cᵥₑᵣ)) |
| Wᵢₙ | W | ceil(W/(3 − cₕₒᵣ)) |
| Cᵢₙ | 1 | 2 |
| h_{d}, d = 0, . . . , 6 | ceil(Hᵢₙ/2^{d}) | ceil(Hᵢₙ/2^{(d<4)?d:d-1}) |
| w_{d}, d = 0, . . . , 6 | ceil(Wᵢₙ/2^{d}) | ceil(Wᵢₙ/2^{(d<4)?d:d-1}) |
| C | Cₚ = 160 | Cₛ = 32 |
| C₃ | 96 + 32 * opldx | 64 |
| C₂ = C₁ | 64 + 64 * opldx | 64 |
| C_{d} | 0 | 160 |

TABLE 3
Supported combinations of output picture
format and scaling factors

| output picture | color sampling mode | | | | |
|---|---|---|---|---|---|
| color sampling mode | coded picture | cᵥₑᵣ | cₕₒᵣ | sᵥₑᵣ | sₕₒᵣ |
| 4:4:4 | 4:4:4 | 2 | 2 | 2 | 2 |
| H_{Y} = H_{UV} = H | 4:2:2 | Not applicable | | | |
| W_{Y} = W_{UV} = W | 4:2:0 | 1 | 1 | 2 | 2 |
| 4:2:2 | 4:4:4 | Not applicable | | | |
| H_{Y} = H_{UV} = H | 4:2:2 | 2 | 1 | 2 | 1 |
| W_{Y} = W; W_{UV} = W/2 | 4:2:0 | 1 | 1 | 2 | 1 |
| 4:2:0 | 4:4:4 | Not applicable | | | |
| H_{Y} = H; H_{UV} = H/2 | 4:2:2 | Not applicable | | | |
| W_{Y} = W; W_{UV} = W/2 | 4:2:0 | 1 | 1 | 1 | 1 |

### 3.(8.4) Latent Space Tiles

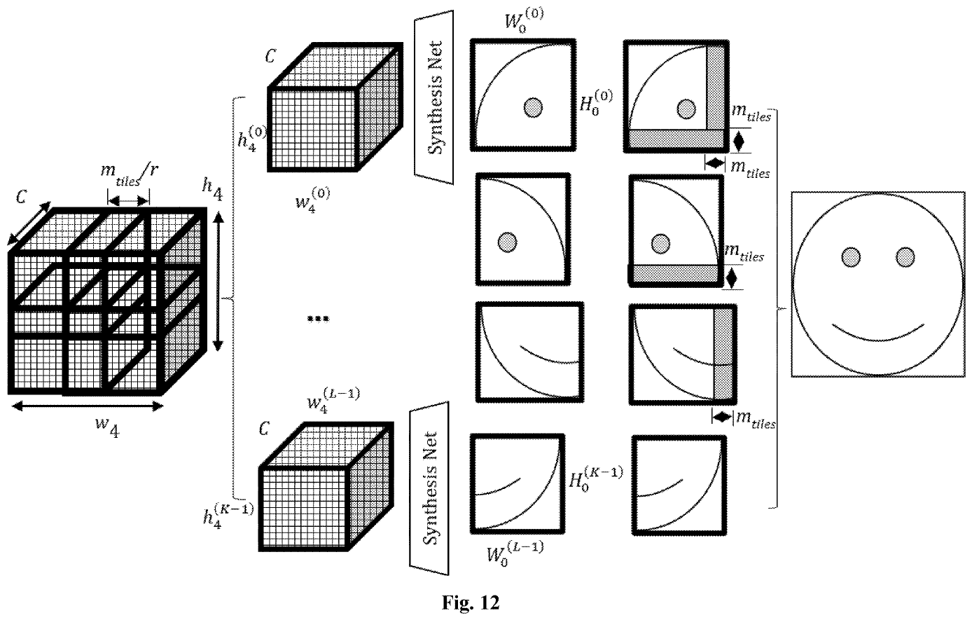

Latent space tiles decoding can be enabled for each component independently by flags signalled in picture header (section 9.3). If tile_enable_Luma or tile_enable_Choma is true then corresponsing component is decoded unsing latent tiling process illustrated on FIG. 12.

The number and location of tiles are determined by values tile size Stile (equal to tile_size_Luma for primary component and tile_size_Chroma for secondary component) and tile overlap mtile (tile_overlap_Luma for primary component tile_overlap_Chroma for secondary component) signalled in picture header (section 9.3). Further, the ratio r=Hᵢₙ/h₄=wᵢₙ/w₄ between signal domain size and latent tensor size is known, which is r=2⁴ for primary and r=2³ for secondary component.

The number of tiles vertically is K=ceil((Hᵢₙ−mₜᵢₗₑ)/(Sₜᵢₗₑ−mₜᵢₗₑ)) and horizontally L=ceil((Wᵢₙ−mₜᵢₗₑ)/(Sₜᵢₗₑ−mₜᵢₗₑ)), where Hᵢₙ, Wᵢₙ are height and width of output color plane. Hᵢₙ, Wᵢₙ are hight and width of output color plane.

For k=0, . . . , K−1 and l=0, . . . , L−1
Define tiles coordinates and sizes

$${i}_{0}^{( k )} = k \cdot ( {S}_{tile} - {m}_{tile} ) - vertical dimension tile start in signal domain ;$$

$${i}_{4}^{( k )} = {i}_{0}^{( k )} / r - vertical dimension tile start in latent space ;$$

$${H}_{0}^{( k )} = ( ( {i}_{0}^{( k )} + {S}_{tile} ) \leq {H}_{in} ) ? {S}_{tile} : {H}_{in} - {i}_{0}^{( k )} - vertical dimension tile size in signal domain ;$$

$${h}_{4}^{( k )} = ceil ( {H}_{0}^{( k )} / r ) - vertical dimension tile size in latent space ;$$

$${j}_{0}^{( l )} = l \cdot ( {S}_{tile} - {m}_{tile} ) - horizontal dimension tile start in signal domain ;$$

$${j}_{4}^{( l )} = {j}_{0}^{( l )} / r - horizontal dimension tile start in latent space ;$$

$${W}_{0}^{( l )} = ( ( {j}_{0}^{( l )} + {S}_{tile} ) \leq {W}_{in} ) ? {S}_{tile} : {W}_{in} - {j}_{0}^{( l )} - horizontal dimension tile size in signal domain ;$$

$${w}_{4}^{( l )} = ceil ( {W}_{0}^{( l )} / r ) - horizontal dimension tile size in latent space .$$

tile latent space tensor

$$For c = 0 , … , C - 1 , i = 0 , … , {h}_{4}^{( k )} - 1 and j = 0 , … , {w}_{4}^{( l )} - 1$$

$${\hat{y}}_{k , l} [ c , i , j ] = \hat{y} [ c , {i}_{4}^{( k )} + i , {j}_{4}^{( l )} + j ]$$

$$For c = 0 , … , {C}_{d} - 1 , i = 0 , … , {h}_{4}^{( k )} - 1 and j = 0 , … , {w}_{4}^{( l )} - 1$$

$${\tilde{y}}_{k , l} [ c , i , j ] = \tilde{y} [ c , {i}_{4}^{( k )} + i , {j}_{4}^{( l )} + j ]$$

Synthesis transform for one tile
   Synthesis transform described in section 8.3 with ŷ_{k,l}, \tilde{y}_{k,l} of sizes

$${h}_{4}^{( k )} and {w}_{4}^{( l )}$$

as inputs and \hat{x}_{k,l} of size

$${H}_{0}^{( k )} and {W}_{0}^{( l )}$$

as output.
Merging reconstructed parts of tensor into one

$${ov}_{1} = ( {j}_{0}^{( k )} == 0 ) ? 0 : {m}_{t i l e} / 2 - overlap used on left boundary of the tile ;$$

$${ov}_{t} = ( {i}_{0}^{( l )} == 0 ) ? 0 : {m}_{t i l e} / 2 - overlap used on top boundary of the tile ;$$

$${ov}_{r} = ( {j}_{0}^{( k )} + {W}_{0}^{( l )} >= {W}_{i n} ) ? 0 : {m}_{t i l e} / 2 - overlap used on right boundary of the tile ;$$

$${ov}_{b} = ( {j}_{0}^{( l )} + {H}_{0}^{( k )} >= {H}_{i n} ) ? 0 : {m}_{t i l e} / 2 - overlap used on bottom boundary of the tile ;$$

$${H}_{1}^{( k )} = {H}_{0}^{( k )} - o {v}_{t} - o {v}_{b}$$

$$verticle dimension tile size in signal domain without tile overlap ;$$

$${W}_{1}^{( l )} = {W}_{0}^{( l )} - o {v}_{1} - o {v}_{r}$$

$$horizontal dimension tile size in signal domain without tile overlap ;$$

$$For c = 0 , … , {C}_{i n} - 1 , i = 0 , … , {H}_{1}^{( k )} - 1 and j = 0 , … , {W}_{1}^{( l )} - 1 ,$$

$$\hat{x} [ c , {i}_{0}^{( k )} + o {v}_{t} + i , {j}_{0}^{( l )} + o {v}_{1} + j ] = {\hat{x}}_{k , l} [ c , {ov}_{t} + i , {ov}_{1} + j ] .$$

Tile size location and overlap signalling in Picture Header is described in Annex C.

### 4. (9.2) Code Stream Layout

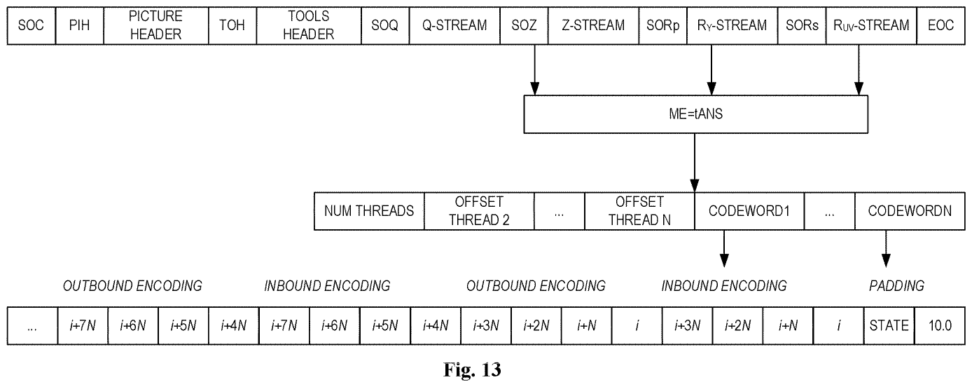

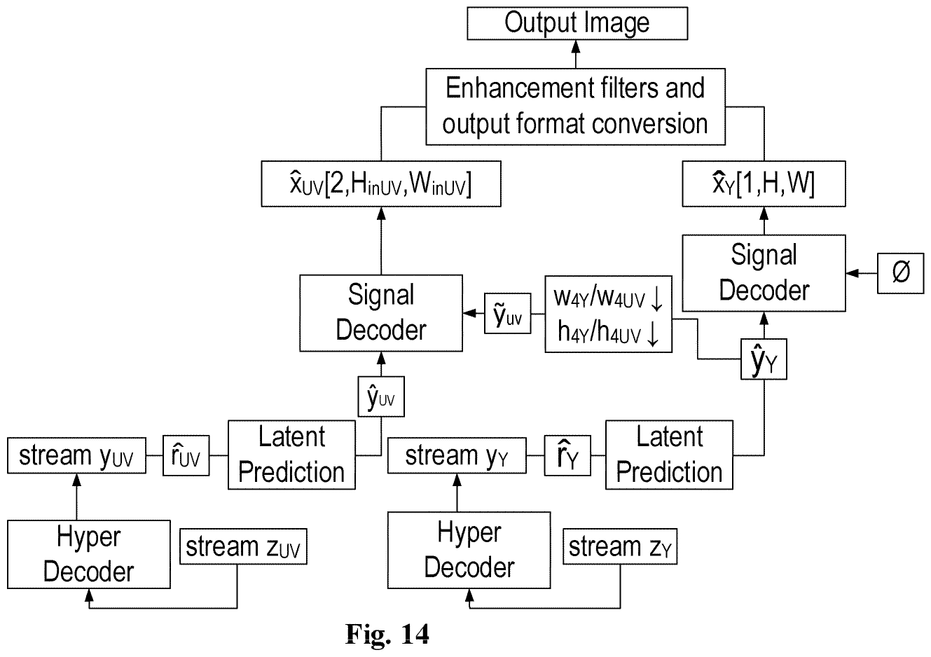

Code stream structure is depicted in FIG. 13. The code stream is composed of six parts with byte boundary, which are:
1. SOC-Start Of Codestream marker;
2. PIH (Picture Header marker) followed by picture header (section 9.3);
3. TOH (Tools Header marker) followed by tools information (section 9.3.1.1);
4. SOQ (start of Quality map marker) followed by code stream;
5. SOZ (Start of Z-stream marker) followed codestream of hyper tensor z, including \hat{z}_{Y} (“stream z_{Y}” in FIG. 14, which illustrates a general JPEG AI decoder structure) and \hat{z}_{UV} (“stream z_{UV}” in FIG. 14);
6. SORp (Start of Residual stream for primary component marker) followed by codestream of primary component residual, which includes \hat{r}_{Y} (“stream y_{Y}” in FIG. 14);
7. SORs (Start of Residual stream for secondary component marker) followed by codestream of secondary component residual, which includes \hat{r}_{UV} (“stream y_{UV}” in FIG. 14);
8. EOC-End Of Codestream marker.

The overall syntax structure of an image is:

| | Descriptor |
|---|---|
| picture( ) { | |
| SOC | u(16) |
| picture_header( ) | |
| tools_header( ) | |
| if (gain_3D_enable_flag) | |
| q_stream( ) | |
| z_stream( ) | |
| r_primary_stream( ) | |
| r_secondary_stream( ) | |
| EOC | u(16) |
| } | |

Each code sream starts with a 16-bit marker. All markers used in this specification are as follows:

| Code assignment | Symbol | Description | Mandatory/Optional |
|---|---|---|---|
| 0xff80 | SOC | Start of codestream | Mandatory |
| 0xff81 | EOC | End of codestream | Mandatory |
| 0xff82 | PIH | Picture header | Mandatory |
| 0xff83 | TOH | Tools header | Optional |
| 0xff84 | VUI | Reserved for | Optional |
| | | rendering information | |
| 0xff85 | xxx | Reserved | Optional |
| 0xff86 | xxx | Reserved | Optional |
| 0xff87 | xxx | Reserved | Optional |
| 0xff88 | SOZ | Start of z | Mandatory |
| 0xff89 | SORp | Start of residual | Mandatory |
| | | (primary component) | |
| 0xff8a | SORs | Start of residual | Mandatory |
| | | (secondary | |
| | | component) | |
| 0xff8b | SOQ | Start of quality map | Optional |
| 0xff8c | xxx | Reserved | Optional |
| 0xff8d | xxx | Reserved | Optional |
| 0xff8e | xxx | Reserved | Optional |
| 0xff8f | xxx | Reserved | Optional |

### 5. (9.3.1) Syntax Table

| | Descriptor |
|---|---|
| picture_header( ) { | |
| PIH | u(16) |
| picture_header_size | u(16) |
| img_width | u(16) |
| img_height | u(16) |
| picture_format | u(2) |
| bit_depth | u(1) |
| bit_c_ver | u(1) |
| bit_c_hor | u(1) |
| bit_s_ver | u(1) |
| bit_s_hor | u(1) |
| color_transform_header( ) | u(1) |
| model_header( ) | |
| } | |

### 6. (9.3.1.1) Model Header

| | Descriptor |
|---|---|
| tile_header_Luma(tile_signaling_type) { | |
| tile_enable_Luma | u(1) |
| if (tile_enable_Luma) | |
| tile_size_Luma | u(13) |
| tile_overlap_Luma | u(8) |
| } | |
| | Descriptor |
| tile_header_Chroma(tile_signaling_type) { | |
| tile_enable_Chroma | u(1) |
| tile_size_Chroma | u(13) |
| tile_overlap_Chroma | u(8) |
| } | |
| | Descriptor |
| color_transform_header( ) { | |
| color_transform_enable | u(1) |
| if( color_transform_enable ) | |
| for ( i=0;i<3;i++ ) | |
| for ( j=0;j<3;j++ ) | |
| color_transform_matrix[i][j] | u(8) |
| for ( i=0;i<3;i++ ) | |
| color_transform_offset[i] | u(8) |
| } | |

### 7. (9.3.2) Picture Header Semantics

Following serves information is signalled:
picture_header_size is the number of bytes in the picture header excluding the first two-byte marker;
img_width plus 64 specifies width of an input picture (from 64 to 65600);
img_height plus 64 specifies height of the input picture (from 64 to 65600);
picture_format is a data format of the output picture (YUV420=0, YUV444=1, sRGB=2, YUV422=3);
bit_depth is a bit-depth the output picture (“0” corresponds to 8 and “1” corresponds to 10);
bit_c_ver is one bit value which defines c_ver=1+bit_c_ver, c_ver controls internal subsampling mode of the secodary component in vertical direction as defined in Table 3 and Table 2. If bit_c_ver is not present in bit-stream then c_ver is equal to 2.
bit_c_hor is one bit value which defines c_hor=1+bit_c_hor, c_ver controls internal subsampling mode of the secodary component in vertical direction as defined in Table 3 and Table 2. If bit_c_hor is not present in bit-stream then c_hor is equal to 2.
bit_s_ver is one bit value which defines s_ver which is used for align coding subsampling mode of the secodary component and subsampling mode in output picture format in vertical direction as defined in Table 3. Usage of s_ver is descried in section 7.6 If bit_c_ver is not present in bit-stream then s_ver is equal to 1.
bit_s_hor is one bit value which defines c_hor=1+bit_c_hor, c_ver controls internal subsampling mode of the secodary component in vertical direction as defined in Table 3 Usage of s_ver is descried in section 7.6 If bit_c_ver is not present in bit-stream then s_hor is equal to 1.
scale_comp[2] are vertical and horizontal ratio between primary and secondary components sizes of coded picture sᵥₑᵣ=scale_comp[0] and sₕₒᵣ=scale_comp[1]; if not present (res_changer_enable=false) then sᵥₑᵣ=2 and sₕₒᵣ=2. Allowed values are listed in Table 3.
independent_beta_uv is a flag (false/true) which indicates do the rate control parameter (B) for primary and secondary components are the same.
beta_displacement_log_y—parameter indicating ratio between rate control parameter beta selected by encoder for primary component and one used in the model training.
betaDisplacementLogY=beta_displacement_log y−2¹¹
beta_displacement_log_uv-parameter indicating ratio between rate control parameter beta selected by encoder for secondary component and one used in the model training.
betaDisplacementLogUV=beta_displacement_log_uv−2¹¹
model_id is an identificator of pre-stored checkpoint with model's weights, model_id=0,1,2,3 or 4.
opIdx is an identificator for operation point, 0 means “base”, 1 means “high” operation point.
tile_enable_Luma and tile_enable_Chroma are enable flags for tiling of primary and secondary components.
tile_size_Luma and tile_size_Chroma are size of tiles for primary and secondary components.
tile_overlap_Luma and tile_overlap_Luma are sizes of tiles overlapping areas for primary and secondary components.
cube_group_flag is 1-bit unsigned integer. cube_group_flag=0 indicates no cube_flag is signalled in one group, and cube flags of one group are set to be 1. cube_group_flag=1 indicates cube flags of one group are signaled.
cube_luma_flag is 1D array of size ((h_{4,Y}+7)»3)·((w_{4,Y}+7)»3), which contains cube flags for primary component. 1 indicates Skip Mode is applied to one cube of residual tensor of primary component \hat{r}_{Y}. 0 indicates Skip Mode is disable for one cube of residual tensor of primary component \hat{r}_{Y}.
cube_chroma_flag is 1D array of size ((h_{4,UV}+7)»3)·((w_{4,UV}+7)»3), which contains cube flags for secondary component. 1 indicates Skip Mode is applied to one cube of residual tensor of secondary component \hat{r}_{UV}. 0 indicates Skip Mode is disable for one cube of residual tensor of secondary component \hat{r}_{UV}.
color_transform_enable is an enable flag for color convertion module.
color_transform_matrix[i] [j] is a matrix of color convertion. If not present (color_transform_enable is false) then default ITU-R BT.709 colour transform is used (refer to section 7.8).
color_transform_offset[i] is an offset for color transformation If not present (color_transform_enable is false) then default ITU-R BT.709 colour transform is used (refer to section 7.8).

### 8. (9.5.1.1) Syntax Table of Hyper Tensor

| | Descriptor |
|---|---|
| z_stream( ) { | |
| SOZ | u(16) |
| z_stream_size | u(24) |
| num_threads_z | u(8) |
| for (i =1; i < num_threads_z; ++i) { | |
| thread_offsets_z[i] | u(24) |
| } | |
| for (i =0; i < num_threads_z; ++i) { | |
| sub_stream[i]=sub_stream_init(i, num_threads_z, thread_offsets_z, z_stream_size) | |
| } | |
| for (ch =0; ch < z_primary_ch; ++ch) { | |
| for (i =0; i < num_threads_z; ++i) { | |
| decode_z_data(sub_stream[i], z_primary[ch][ ], ch, z_primary_width, z_primary_height, | |
| i, num_threads_z) | |
| } | |
| } | |
| for (ch =0; ch < z_secondary_ch; ++ch) { | |
| for (i =0; i < num_threads_z; ++i) { | |
| decode_z_data(sub_stream[i], z_secondary[ch][ ], ch, z_secondary_width, | |
| z_secondary_height, i, num_threads_z) | |
| } | |
| } | |
| } | |

### 9. (9.5.2) Quality Map Information Decoder

The input of this process is
Codestream for quality_map;
Indicators for sigma tables which are decoded in picture header:
   quality_map_entropy_index_y for primary component.
   quality_map_entropy_index_uv for secondary component.

The output of this process is
quality_map_delta_Y is an array of size [w_{4Y}, h_{4Y}] with information used for deriving scaling factor (section 12.2) for primary component residual tensor.
quality_map_delta_UV is an array of size [w_{4UV}, h_{4UV}] with information used for deriving scaling factor (section 12.2) for secondary component residual tensor.

Here sizes [w_{4Y}, h_{4Y}] and [w_{4UV}, h_{4UV}] are defined in Table 2.
q_primary_sigma_Idx is a 1D array of size h_{4Y}×w_{4Y}, and each element in this array is equal to
q_sigma_Idx [quality_map_entropy_index_y], where the q_sigma_Idx[k] is derived according to Table 4.
q_secondary_sigma_Idx is a 1D array of size h_{4UV}×w_{4UV}, and each element in this array is equal to q_sigma_Idx [quality_map_entropy_index_uv].
q_primary is a 1D array of size h_{4Y}×w_{4Y}, and quality_map_delta_Y is determined by:
   quality_map_delta_Y[i, j]=q_primary[i×w_{4Y}+j], for j=0 . . . w_{4Y}−1, and i=0 . . . h_{4Y}−1.
q_secondary is a 1D array of size h_{4UV}×w_{4UV}, and quality_map_delta_UV is determined by
   quality_map_delta_UV[i, j]=q_secondary[i×w_{4UV}+j], for j=0 . . . w_{4UV}−1, and i=0 . . . h_{4UV}−1.

TABLE 4
Determining q_sigma_Idx for quality map delta decoding

| | | | | | | | | |
|---|---|---|---|---|---|---|---|---|
| k | 0 | 1 | 2 | 3 | 4 | 5 | 6 | 7 |
| q_sigma_Idx[k] | 0 | 4 | 5 | 6 | 8 | 10 | 14 | 18 |

### 10. (9.5.2.1) Syntax Table of Quality Map Information Tensor

| | Descriptor |
|---|---|
| q_stream( ) { | |
| SOQ | u(16) |
| q_stream_size | u(24) |
| num_threads_q | u(8) |
| for (i =1; i < num_threads_q; ++i) { | |
| thread_offsets_q[i] | u(24) |
| } | |
| for (i =0; i < num_threads_q; ++i) { | |
| sub_stream[i]=sub_stream_init(i, num_threads_q, thread_offsets_q, q_stream_size) | |
| } | |
| for (i =0; i < num_threads_q; ++i) { | |
| decode_r_data(sub_stream[i], q primary[ ], q_primary_sigma_Idx[ ], i, num_threads_q) | |
| } | |
| for (i =0; i < num_threads_q; ++i) { | |
| decode_r_data(sub_stream[i], q_secondary[ ], q_secondary_sigma_Idx[ ], i, | |
| num_threads_q) | |
| } | |
| } | |

### 11. (9.5.3) Primary Residual Stream Decoder

The input of this process is
Primary component residual codestream;
mask_skip[Cₚ, h_{4Y}, w_{4Y}] generated by Skip Mask generation (section 13.3.2) for primary component;
sigma_Idx_primary—tensor of size [Cₚ, h_{4Y}, w_{4Y}] which is the output of Sigma quantization (section 10.8) for primary component.

The output of this process is
r_primary—one dimensional array {s}of residual tensor elements which is an input of decoder skip process (section 13.3.4) for primary component.

Here sizes Cₚ, w_{4Y}, h_{4Y} are defined in Table 2. A one dimensional array sigma_Idx_primary_1D is determined though following steps:
Set k=0
For c=0 . . . Cₚ−1,
   For i=0 . . . h_{4Y}−1.
      For j=0 . . . w_{4Y}−1
         if mask_skip[c,i, j] is equal to True, sigma_Idx_primary_1D[k] is set to equal to sigma_Idx_primary[c, i, j] and increase k by 1.

12. (9.5.3.1) Syntax table of primary residual tensor

| | Descriptor |
|---|---|
| r_primary_stream( ) { | |
| SOR | u(16) |
| r_primary_stream_size | u(32) |
| num_threads_r_primary | u(8) |
| for (i =1; i < num_threads_r_primary; ++i) { | |
| thread_offsets_r_primary[i] | u(32) |
| } | |
| for (i=0; i < num_threads_r_primary; ++i) { | |
| sub_stream[i]=sub_stream_init(i, num_threads_r_primary, thread_offsets_r_primary, | |
| r_primary_stream_size) | |
| decode_r_data(sub_stream[i], r_primary[], sigma_Idx primary[], i, num_threads_r_primary) | |
| } | |
| } | |

### 13. (9.5.4) Secondary Residual Stream Decoder

The input of this process is
Codestream for secondary component residual;
mask_skip[Cₛ, h_{4UV}, w_{4UV}] generated by Skip Mask generation (section 13.3.2) for secondary component;
sigma_Idx_secondary—tensor of size [Cₛ, h_{4UV}, w_{4UV}] which is the output of Sigma quantization (section 10.8) for secondary component.

The output of this process is
r_secondary—one dimensional array {s} of residual tensor elements which is an input of decoder skip process (section 13.3.4) for secondary component.

Here sizes Cₛ, h_{4UV}, w_{4UV} are defined in Table 2. A one dimensional array sigma_Idx_secondary_1D is determined though following steps:
Set k=0
For c=0 . . . Cₚ−1,
   For i=0 . . . h_{4Y}−1,
      For j=0 . . . W_{4Y}−1
      if mask_skip[c,i, j] is equal to True, sigma_Idx_secondary_1D[k] is set to equal to sigma_Idx_secondary[c, i, j] and increase k by 1.

### 14. (9.5.4.1) Syntax Table of Secondary Residual Tensor

| | Descriptor |
|---|---|
| r_secondary_stream( ) { | |
| SOR | u(16) |
| r_secondary_stream_size | u(24) |
| num_threads_r_secondary | u(8) |
| for (i =1; i < num_threads_r_secondary; ++i) { | |
| thread_offsets_r_secondary[i] | u(24) |
| } | |
| for (i=0; i < num_threads_r_secondary; ++i) { | |
| sub_stream[i]=sub_stream_init(i, num_threads_r_secondary, thread_offsets_r_secondary, | |
| r_secondary_stream_size) | |
| decode_r_data(sub_stream[i], r_secondary[], sigma_Idx_secondary[], i, | |
| num_threads_r_secondary) | |
| } | |
| } | |

### 15. (10.3) Hyper Scale Decoder

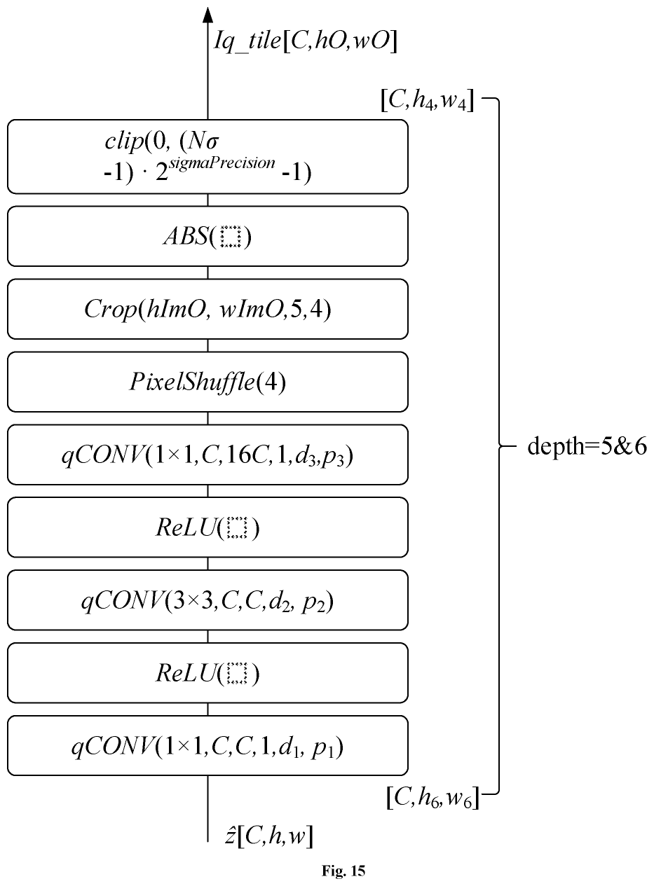

Hyper scale decoder net is depicted in FIG. 15.

The input of hyper scale decoder is
\hat{z}[C, h₆, w₆] reconstructed hyper tensor,
sizes of input/output tensor Hᵢₙ, Wᵢₙ,
operation point indicator opIdx,
model parameters for Hyper Scale Decoder Net defined by pair (modelIdx, opIdx), all multiplier parameters in those models are 8-bits integer.

The output of hyper scale decoder is standard deviation logarithm tensor I_{σ}[C, h₄, w₄] with integer values in a range 0≤I_{σ}<((N_{σ}−1)«sigmaPrecision), where No, sigmaPrecision are defined in section 0. Sizes of those tensors for primary and secondary components are listed in Table 2.

All operation in scalable hyper decoder are integer, an accumulator in all computations is within 32 bits integer diapason, multipliers in model parameters are quantized to 8-bits integer. This guarantees bit-exact behaviour of this neural network module. Hyper scale decoder uses special type of operations quantized convolutions. For each quantized convolution in the process the set of clipping values {dₖ} and de-scaling shifts parameters {pₖ} (1≤k≤3) are specified for each channel. All clipping values in quantized convolutions are dₖ=2⁷. De-scaling shifts {pₖ} are provided in section 15.6.
NOTE—the magnitude of integerized weights in quantized model doesn't exceed 2⁷, shift and clipping value combination ensures the register of quantized convolution is within 32-bits.

The sequence of operations in this module doesn't depend on operation point indicator (opIdx), but model parameters are different for base and high operation point.

Hyper scale decoder starts with quantized convolution kernel size 1×1, stride 1, followed by rectified linear unit. Then there is a stride 1 quantized convolution with kernel size 3×3, followed by rectified linear unit. The next stride 1 quantized convolution (kernel size 1×1) increases the number of channels to 16C. It is followed by pixel shuffle (stride 4), which brings number of channels back to C. The cropping layer (stride 4, depth 5) ensures the size of output tensor is [C, h₄, w₄]. The process concluded with abs operation.

Model with weights are storied in electronic attachment, in format specicied in section 4.8 and locates in <oper_point>/model_<MID>/<COMP>/hyper_scale_decoder.onnx, where <oper_point> is “base” or “high”, <MID> is an integer from 0 to 5, <COMP> is “primary” or “secondary”.

### 16. (11.2) Hyper Decoder

The learning-based hyper decoder consists of two independent pipe-lines with identical neural network architecture, except input size and number of channels.

The input of this process is
\hat{z}[C, h₆, w₆] reconstructed hyper latent tensor,
model parameters for Hyper Decoder Net defined by (modelIdx),
operation point indicator opIdx.

The output of this process is
p[Cₚ, h₄, w₄] is explicit prediction (part of predicton tensor derived from explicitly signalled information), with channels size Cₚ=(opIdx+1)C.

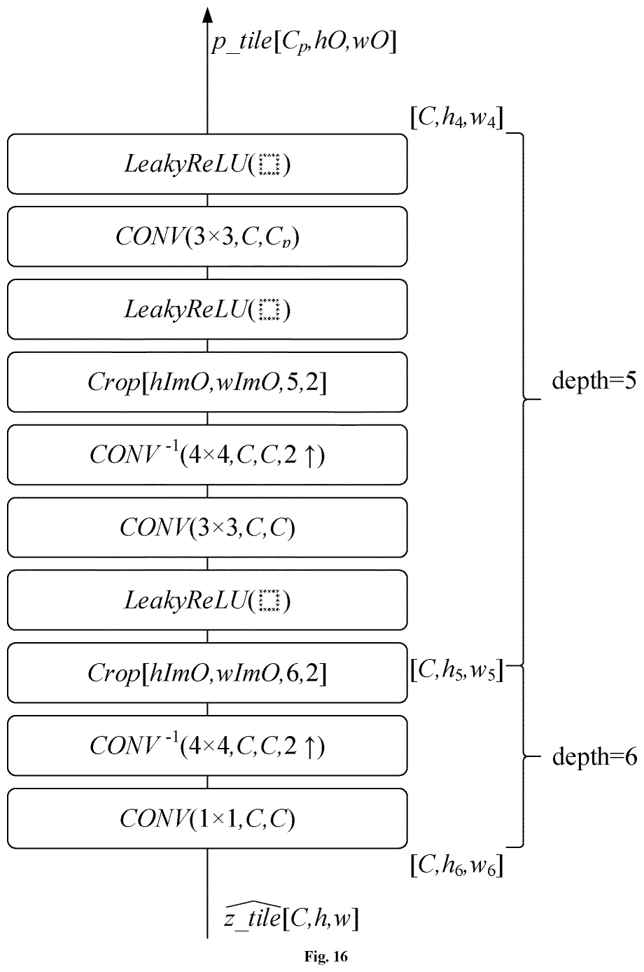

Hyper decoder process is depicted in FIG. 16.

Hyper decoder starts stride 1 convolution with kernel size 1×1, followed by inverse convolution (stride 2, kernel size 4×4), cropping layer (depth 6) and leacky rectified linear unit. Next step is stride 1 convolution with kernel size 3×3, followed by inverse convolution (stride 2, kernel size 4×4), cropping layer (depth 5) and leacky rectified linear unit. Number of channels kep un-changed till this point (equal to number of channels C of input tensor). Hyper decoder concluded by stride 1 convolution with kernel size 3×3 which increases number of channels to 2C for high operation point and keeps number fo channes unchanged for base operation point followed by leacky rectified linear unit.

Model with weights are storied in electronic attachment, in format specicied in section 4.8 and locates in <oper_point>/model_<MID>/<COMP>/hyper_decoder.onnx, where <oper_point> is “base” or “high”, <MID> is an integer from 0 to 5, <COMP> is “primary” or “secondary”.

### 17. (11.3) Latent Tensor Reconstruction Process

The input of this process is
operation point indicator opIdx,
\hat{r}[C, h₄, w₄] reconstructed residual tensor, which is an out out of SKIP Model process (13.3.4),
p[Cₚ, h₄, w₄] explicit prediction, with channels size Cₚ=(opldx+1)C, which is an output of Hyper Decoder (11.2),

The output of this process is
ŷ′[C, h₄, w₄] reconstructed latent tensor.

The process is as follows.

If opldx==0 (base operation point) then multi-stage context modelling process is by-passed,
explicit prediction is added to residual ŷ′=\hat{r}+p[0:C−1, h₄, w₄]:

If opldx==1 (high operation point) then:
Multi-stage Context Modelling process (section 11.4) is used.

### 18. (11.4) Multistage Context Modelling

The input of this process is
\hat{r}[C, h₄, w₄] reconstructed residual tensor, which is an out out of SKIP Model process (13.3.4),
p[2C, h₄, w₄] explicit prediction, which is an output of Hyper Decoder (11.2),
Eight MCMₖ, k=0, . . . 7 models with parameters defined by (modelIdx, k),

The output of this process is
ŷ′[C, h₄, w₄] reconstructed latent tensor.

The process consists of following steps:
padding layer (depth 5, stride 2) and down-shuffle (11.5.1) M=2 of explicit prediction tensor p[2C, h₄, w₄] to \ddot{p}[8C, h₅, w₅] re-shaped prediction tensor,
padding layer (depth 5, stride 2) and down-shuffle (11.5.1) M=1 of reconstructed resdiaul \hat{r}[C, h₄, w₄] to \ddot{r}[4C, h₅, w₅] re-shaped residual tensor,
split \ddot{p}[8C, h₄, w₄] into four parts \ddot{p}ₗ=\ddot{p}[2lC:2(l+1)C−1, h₅, w₅], l=0, . . . ,3 (each parts consists of 2C out of 8C channels),
split \ddot{r}[4C, h₄, w₄] into eight parts \ddot{r}ₖ=\ddot{r}[kC/2:(k+1)C/2−1, h₅, w₅], k=0, . . . ,7 (each parts consists of C/2 out of 4C channels),
For k=0, . . . ,3
   MCM (k) process which
      takes as an input
         {ÿₘ}, m=0, . . . , k−1 previously reconstructed parts of re-shaped latent space tensor,
         \ddot{r}ₖ—collocated part of reconstructed residual tensor,
         \ddot{p}_{k%4}—part of re-shaped explicit prediction tensor,
      outputs
         produces ÿₖ=ÿₖ[kC/2:(k+1)C/2−1, h₅, w₅].
Channel net process (11.5.4) over ÿ[0:(2C−1, h₅, w₅] tensor.
For k=3, . . . ,7
   MCM(k) process which
      takes as an input
         {ÿₘ}, m=0, . . . , k−1 previously reconstructed parts of re-shaped latent space tensor,
         \ddot{r}ₖ—collocated part of reconstructed residual tensor,
         \ddot{p}_{k%4}—part of re-shaped explicit prediction tensor.
      outputs
         produces ÿₖ=ÿ[kC/2:(k+1)C/2−1, h₅, w₅].
up-shuffle (11.5.2) M=2 and cropping layer (depth 5, stride 2) ÿ[4C, h₅, w₅] to ŷ′[C, h₄, w₄].
up-shuffle (11.5.2) M=2 and cropping layer (depth 5, stride 2) \ddot{μ}[4C, h₅, w₅] to μ[C, h₄, w₄] (to be further used in LSBS process 13.4.2).

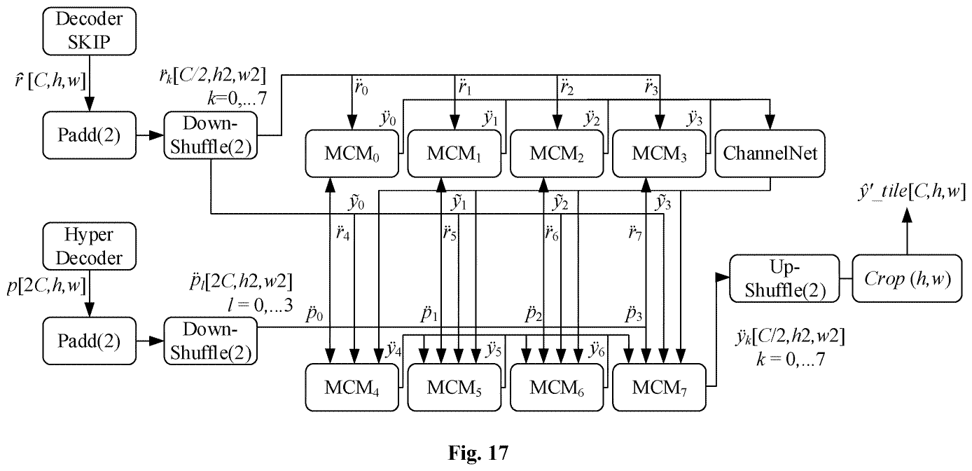

Multi-stage context modelling process is depicted in FIG. 17. This is a recurrent process: later stages uses previously obtained elements of output tensor as an input. Data flow which corresponds usage of previous stages output is marked with arrows in FIG. 17.

Models with weights are storied in electronic attachment, in format specicied in section 4.8 and locates in high/model_<MID>/<COMP>/MCM/stage<N>.onnx, where <MID> is an integer from 0 to 5, <COMP> is “primary” or “secondary”, <N> is a number of MCM's stage from 0 to 7.

### 19. (13.3.4) Decoder Side SKIP Operation

At the decoder, the inputs of skip mode process are
1D array s [num_res_elements] after decoding by me-tANS (section 9.5.2) to from the “stream−y”,
mask_skip [C,h₄,w₄].

The output of this process is
the residual tensor \hat{r}[C,h₄,w₄].

The output of the lossless decoding process is a 1D array {sₖ}, whose size is equal to the total number of “1”'s in the mask_skip [C,h₄,w₄] tensor.

In other words, the mask_skip [C,h₄,w₄] tensor determines which samples of the residual tensor \hat{r} are included in the bitstream. All of the other samples of the quantized residual tensor are inferred to be equal to zero. The process of residual skip mode at the decoder is as follows:
Dimensions [C, h₄, w₄] are set equal to number of channels, height and width of the sigma tensor o (Table 2).
Tensors \hat{r}[C,h₄,w₄] is initialized to be equal to all zeros.
The counter k=0.
The following ordered steps are applied:
For c=0 . . . C−1,
   For i=0 . . . h₄−1
      For, j=0 . . . w₄−1
         if mask_skip[c,i,j] is equal to True, \hat{r}[c, i, j]=mask_skip [c,i,j]·(s[k]−2¹⁶⁻¹+1), and increase k by 1;
         otherwise, \hat{r}[c, i, j]=0.

### 20. (14.1.1) Inter Channel Correlation Information Filter Tiling and Output Selection Process

The ICCI filter processes the input in tiles using the same method described in Section 8.4. The tile size icci_tile_size and tile overlap icci_tile_overlap are same for the primary (Luma) and secondary (Chroma) components and signalled in picture header (Section 9.3). The ratio r between input domain size and output tensor size is fixed to 1 for each component. The minimum tile size is limited to 176 for the stable computation of the model selection explained next.

In total, 10 ICCI filters are included into the design. In each tile tileID for each color component comp=0 . . . 2 (“0”−“y”, “1”−“u”, “2”−“v”) the filter is selected based on icci_model_idx[comp][tileID] value which is coded in picture header (Section 9.3). In case icci_model_idx=0, the ICCI processing is bypassed.

### 21. (14.2) Adaptive Upsampler

This section details the primary component guaided adaptive upsampler process. This process provides enhancement of secondary components (colour information planes) of image utilising information from primary component.

This process is enabled if EFE_upsampler_enabled_flag is true.

The input of this process is
\hat{x}_{Y}[1, H_{Y}, W_{Y}] (output of synthesis transfor for primary component),
\hat{x}_{UV}[2, Hin_{UV}, Win_{UV}] (output of synthesis transfor for secondary component),

The output of this process is
enhanced secondary component \hat{x}′_{UV}[2, H_{UV}, W_{UV}] which goes to the ICCI filter block (section 14.1) and \hat{x}″_{UV}[2, H_{UV}, W_{UV}] which goes to the non-linear filter block (section 14.3).

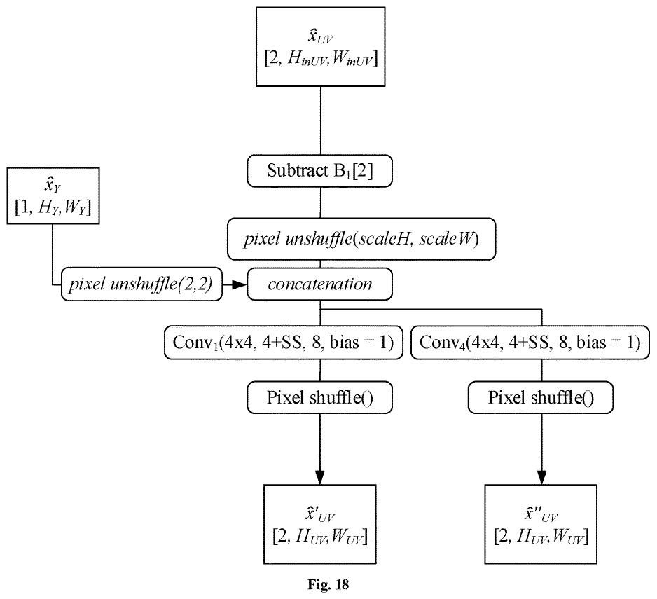

FIG. 18 illustrates an example implementation of primary component guided adaptive up-sampling filter. If EFE_upsampler_enabled_flag is equal to 0, the \hat{x}′_{UV}[2, H, W] is up-sampled by bi-cubic interpolation as described in section 7.6. Otherwise the following ordered steps are performed:
The parsing process according to parsing table in Section 9.4.1 is invoked to obtain W_{1A}, W_{1B}, w_{4A}, w_{4B} and B₁.
Tiling process is as described in section 14.2.2 is invoked with parsed syntax elements as inputs and Tile1 tensor as output.
Parameter update process as specified in section Section 14.2.1. is invoked with w_{4A} and W_{1A} as inputs and modified w_{4A} and W_{1A} as outputs.
B₁[2] is vector is subtracted channelwise from \hat{x}′_{UV}[2, Hin_{UV}, Win_{UV}].

$$U [ 2 \cdot {scale}_{ver} \cdot {scale}_{h o r} , \frac{H + 1}{2} , \frac{W + 1}{2} ] and Y [ 4 , \frac{H + 1}{2} , \frac{W + 1}{2} ]$$

are set equal to pixelUnshuffle (\hat{x}′_{UV}, scaleᵥₑᵣ, scaleₕₒᵣ) and pixelUnshuffle(\hat{x}′_{Y}, 2,2) respectively.
For x=0 . . . (W+1)/2−1, y=0 . . . (H+1)/2−1, k=0 . . . 1, i=0 . . . oᵥₑᵣ−1, j=0 . . . oₕₒᵣ−1 the following is performed:
   ch=4k+2i+j
   chₒᵤₜ=k·oᵥₑᵣ·oₕₒᵣ+oₕₒᵣ·i+j
   chᵢₙ=k·scaleᵥₑᵣ·scaleₕₒᵣ+scaleₕₒᵣ·(i % scaleᵥₑᵣ)+(j % scaleₕₒᵣ)
   t_{idx}=Tile1[k, y, x]
   U′[chₒᵤₜ, y, x]=U[chᵢₙ, y, x]*W_{4A}[t_{idx}, ch]+Y[2i+j, y, x]*w_{4B}[t_{idx}, k]+B₁[k]
   U′[chₒᵤₜ, y, x]=U[chᵢₙ, y, x]*W_{1A}[0, ch]+Y[2i+j, y, x]*W_{1B} [0, k]+B₁[k]
\hat{x}′_{UV}[2, H_{UV}, W_{UV}] and \hat{x}″_{UV}[2, H_{UV}, W_{UV}] are set equal to pixelshuffle(U′, oᵥₑᵣ, oₕₒᵣ) and pixelshuffle(U″, oᵥₑᵣ, oₕₒᵣ) respectively.

### 22. (14.4.1) LEF General Process

LEF process receives primary variance tensor \hat{σ}_{Y}[Cₚ, h_{4,Y}, w_{4,Y}] and reconstructed primary \hat{x}′_{Y}[1, H, W] as inputs. The output of LEF process is edge enhanced modified \hat{x}′_{Y}[1, H, W].

The following ordered steps are performed:
Picture header parsing process is invoked as described in section Section 9.3. to obtain targetBppIdx,
chIdx is set equal to reference_channel_idx_table[tagetBppldx],
The ô_{Y_channel}¹[1, H_{Y}, W_{Y}] tensor is obtained as follows, for i=0 . . . H_{Y}−1, j=0 . . . W_{Y}−1,
   \hat{σ}_{Y_channel}¹[0, i, j]=\hat{σ}_{Y}[chIdx, floor(i·h_{4,Y}÷H_{Y}), floor(i·w_{4,Y}÷W_{Y})],
thr[3]=luma_edge_filter_thr_list_table[targetBppIdx],
intensity[4]=luma_edge_filter_intensity_list[targetBppIdx],
\hat{x}′_{Y}=\hat{x}′_{Y}÷255,
\hat{x}_{blur}=\hat{x}′_{Y}*kernel,
\hat{x}_{edge}=\hat{x}′_{Y}−\hat{x}_{blur},
\hat{σ}_{Y_channel}¹[1, H_{Y}, W_{Y}]=σ_{Y_channel}¹[1, H_{Y}, W_{Y}]÷8190,

For i=0 . . . H_{Y}−1, j=0 . . . W_{Y}−1;

$$tIdx = \{ \begin{matrix}0 , & {\hat{σ}}_{{Y}_{channel}}^{1} [ 0 , i , j ] < thr [ 0 ] \\ 1 , & thr [ 0 ] \leq {\hat{σ}}_{{Y}_{channel}}^{1} [ 0 , i , j ] < thr [ 1 ] \\ 2 , & thr [ 1 ] \leq {\hat{σ}}_{{Y}_{channel}}^{1} [ 0 , i , j ] < thr [ 2 ] \\ 3 , & thr [ 2 ] \leq {\hat{σ}}_{{Y}_{channel}}^{1} [ 0 , i , j ]\end{matrix}$$

Ŷ [i, j]=\hat{x}_{edge}[0, i, j]*intensity[tIdx]+\hat{x}_{blur}[0, i, j],
Ŷ is modified as follows, for i=0 . . . H_{Y}−1, j=0 . . . W_{Y}−1:
Ŷ[i,j]=clip(0,1,Ŷ[i, j])·255.

In this process zero padding is used when the indices of a tensor exceeds the tensor boundaries.

The weights tensor kernel is defined as follows:

$$kernel = [ \begin{matrix}1 \div 13 & 1 \div 13 & 1 \div 13 \\ 1 \div 13 & 5 \div 13 & 1 \div 13 \\ 1 \div 13 & 1 \div 13 & 1 \div 13\end{matrix} ]$$

The reference_channel_idx_table is defined as follows:
reference_channel_idx_table=[23,23,65,65,65]

The luma_edge_filter_intensity_list is as follows:

| luma_edge_filter_intensity_list [X][Y] | Y = 0 | Y = 1 | Y = 2 | Y = 3 |
|---|---|---|---|---|
| X = 0 | 1.00 | 1.10 | 1.25 | 1.40 |
| X = 1 | 1.00 | 1.08 | 1.12 | 1.16 |
| X = 2 | 1.00 | 1.05 | 1.06 | 1.07 |
| X = 3 | 1.00 | 1.02 | 1.03 | 1.04 |
| X = 4 | 1.00 | 1.01 | 1.02 | 1.03 |

The luma_edge_filter_thr_list_table is defined as follows:

| luma_edge_filter_thr_list_table [X][Y] | Y = 0 | Y = 1 | Y = 2 |
|---|---|---|---|
| X = 0 | 0.3 | 2.0 | 6.0 |
| X = 1 | 0.4 | 3.0 | 7.0 |
| X = 2 | 0.5 | 6.0 | 10.0 |
| X = 3 | 0.6 | 7.0 | 12.0 |
| X = 4 | 0.7 | 8.0 | 14.0 |

### 3. Problems

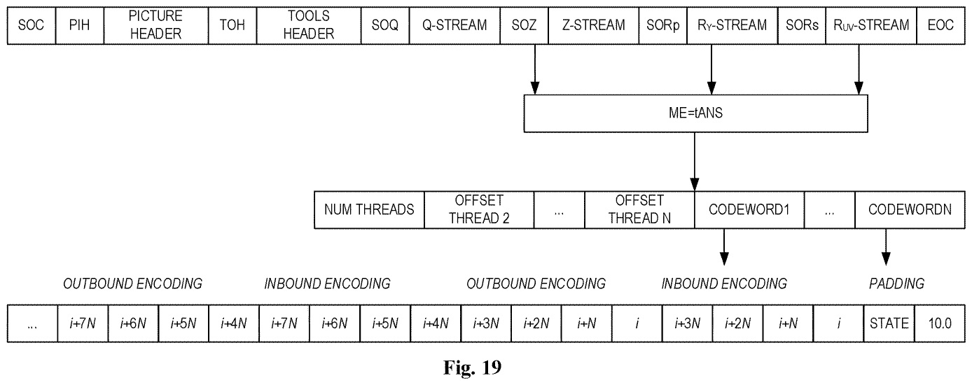

The following limitations present in the existing design:
1) As shown in FIG. 19, the coded bits of the Q-stream, Z-stream, Ry-stream, and R_{UV}-stream in the bitstream follow a sequential order. Therefore, even the synthesis transform has tiling-based mechanism, the whole bitstream must be decoded to generate the regional decoded image, which introduces additional decoding complexity and potential inconvenience in real applications.
2) Although JPEG AI supports splitting the latents into multiple partitions in the synthesis transform part, the multiple partitions have to be decoded in a sequential order since each subsequent decoded area uses the reference pixels from the previously decoded areas. Only decoding a specified region is not supported. The use cases of only decoding a certain region include omnidirectional video-based applications, multi-page document sharing on social media etc.
3) Currently, it is possible to partition a picture into multiple regions, and at the same time enable the correct decoding of a subset of each region independently from other regions by having tiles being subsets of regions and alignment of tiling between luma and chroma. However, there lacks a high-level indication of this regional access capability, e.g., in the picture header.
4) Currently, it is possible to partition a picture into multiple regions, and at the same time enable the correct decoding of a subset of each region independently from other regions. However, it is not possible to enable correct decoding of the entire regions.

### 4. Detailed Solutions

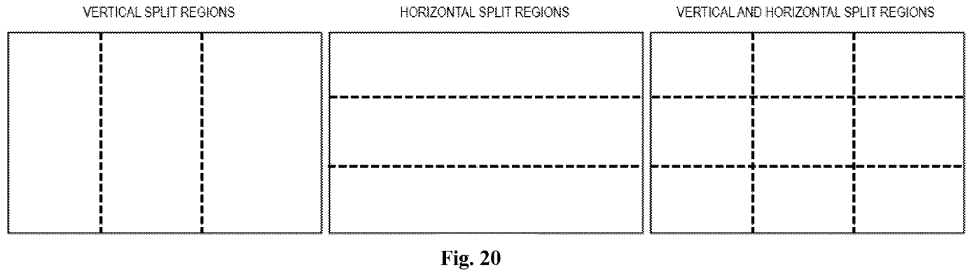

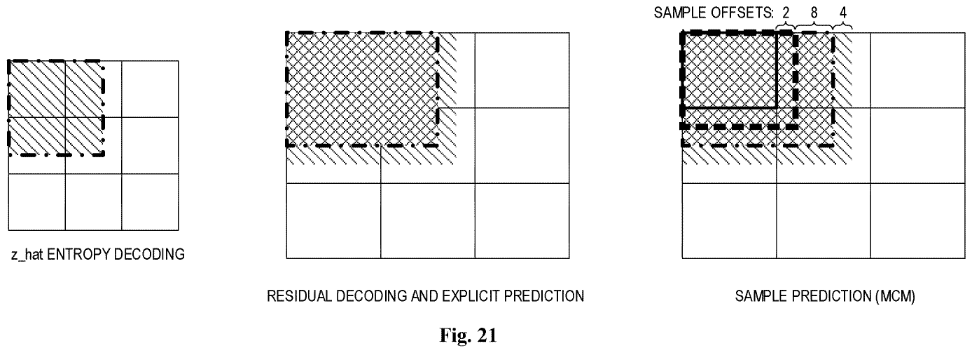

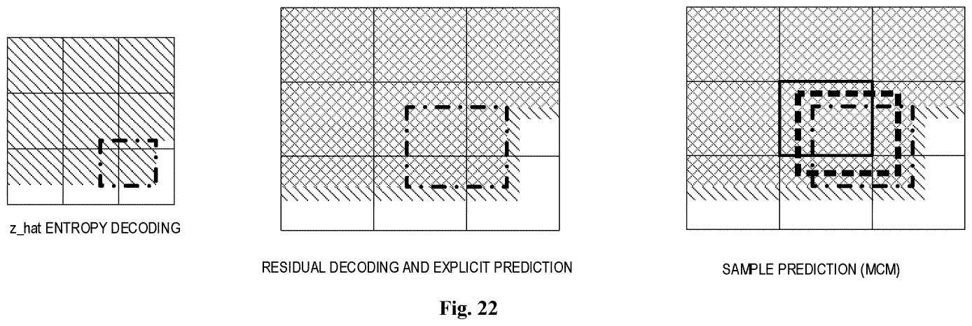

To solve the above-described problems, methods as summarized below are disclosed. The solutions should be considered as examples to explain the general concepts and should not be interpreted in a narrow way. Furthermore, these solutions can be applied individually or combined in any manner.
1) It is proposed that a subset (such as a subpicture, or a tile, or a slice, or a region) of samples in a picture can be reconstructed independently from samples in the picture out of the subset, with a NN-based decoder such as a JPEG-AI decoder.
2) To realize item 1), the following methods may apply:
   a. The bitstream is structured to region-based to replace the picture-based.
   b. The picture may be split into multiple regions, either vertically or horizontally or both vertically and horizontally. FIG. 20 illustrates possible split types.
      i. The number of horizontal (row) regions and vertical (column) regions may use two flags/signals to indicate and signaled in the bitstreams.
      ii. For each of the split region, a signal/flag may be used to indicate if the current region is an independently decoded region, i.e., the region can be independently decoded without relying on other regions.
      iii. An algorithm may be designed to derive the region sizes and the specific starting and ending location of each region give the input picture size. In the algorithm, additional restrictions may apply such as the allowed minimal region size or maximum regional size.
         a. Alternatively, the size and/or location information may be explicitly indicated in the bitstream.
   c. A starting code/signal may be signaled into the bitstream to indicate the start of a region.
3) To alleviate the region boundary artifacts, overlapping is applied to dependent regions as shown in FIG. 21. The overlapping mechanism may be used for hyper tensor, residual latents and synthesis transform.
   a. In one example, the number of overlapped pixels could be.
      i. Entropy decoding of \hat{z}:
         1. No overlap around the region.
      ii. Hyper decoder and hyper scale decoder:
         1. One sample overlap on each side at input.
         2. Four samples discarded on each side at output.
      iii. MCM:
         Eight samples overlap on each side at input.
         Eight samples discarded on each side at output.
      iv. Synthesis transforms:
         Two samples overlap on each side at input.
         Thirty-two or sixteen samples discarded on each side at output.
4) Alternative to 3), shifted regions may be used as illustrated in FIG. 22. The tiles are a shifted version for the synthesis transform of the original tiles in the JPEG AI software. The structure makes the pipelining possible, making a faster decoder.

### General Aspects

5) Additional operations may be applied to or with the proposed method.
   a) A syntax element (a.k.a. an indication) disclosed above may be binarized as a flag, a fixed length code, an EG (x) code, a unary code, a truncated unary code, a truncated binary code, etc. It can be signed or unsigned.
   b) A syntax element representing a coding tool or a coding method may not be signalled and implicitly determined to be unused, if the coding tool or the coding method is regarded as not applicable or cannot be used.
   c) A syntax element disclosed above may be coded with at least one context model. Or it may be bypass coded.
   d) A syntax element disclosed above may be signaled in a conditional way.
   e) A syntax element disclosed above may be signaled at block level/sequence level/group of pictures level/picture level/slice level/tile group level.
   f) Whether to and/or how to apply the disclosed methods above may be signalled at block level/sequence level/group of pictures level/picture level/slice level/tile group level.
      g) Whether to and/or how to apply the disclosed methods above may be dependent on coded information, such as colour format, colour component, slice/picture type.
6) The proposed methods may be applied to other image/video compression solutions with NN-based coding tools involved.

### 5. EMBODIMENTS

Below are some example embodiments for the detailed solution aspects summarized above in Section 4. Some relevant parts that have been added or modified are shown by using bolded words (e.g., this format indicates added text), and some of the deleted parts are shown by using words in italics between double curly brackets (e.g., {{this format indicates deleted text}}). There may be some other changes that are not highlighted. It should be understood that only markings in this section are intended to emphasize at least part of proposed changes.

### 5.1. Embodiment 1

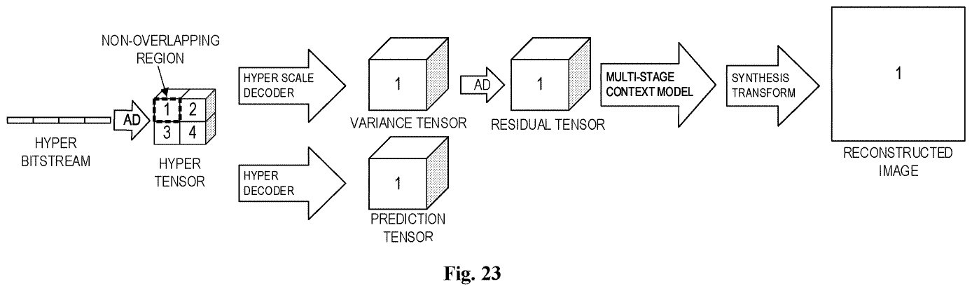

In one example, the region-based decoding is implemented with the overlapping region mechanism as illustrated in FIG. 13. The high-level framework is shown in FIG. 23. The picture is split into multiple regions either horizontally, or vertically, or both horizontally and vertically. There may be a flag/code associated with each region in the bitstream indicating if the region is an independently decoded region. To ensure the correctly decodable of the independent regions, the overlapping region is only applied to the dependent regions. The number of overlapped pixels may vary for hyper latent, residual latent, MCM and synthesis transforms.

### 5.2. Embodiment 2

FIG. 24 illustrates a flag is used to control region split mechanism, either overlapped region (as shown in FIG. 21) or shifted region (as shown in FIG. 22).

In one example, in the decoding process, there may exist both the shifted region mechanism and the overlapping region mechanism. And a flag/signaled code is used to control region split mechanism selection. An example may be implemented as follows.
Synthesis transform is implemented using the overlap region.
Entropy decoding part is implemented using the overlap region.
   Alternatively, the entropy decoding part is implemented using the shifted region.
A switch control is used to select the region partitioning.

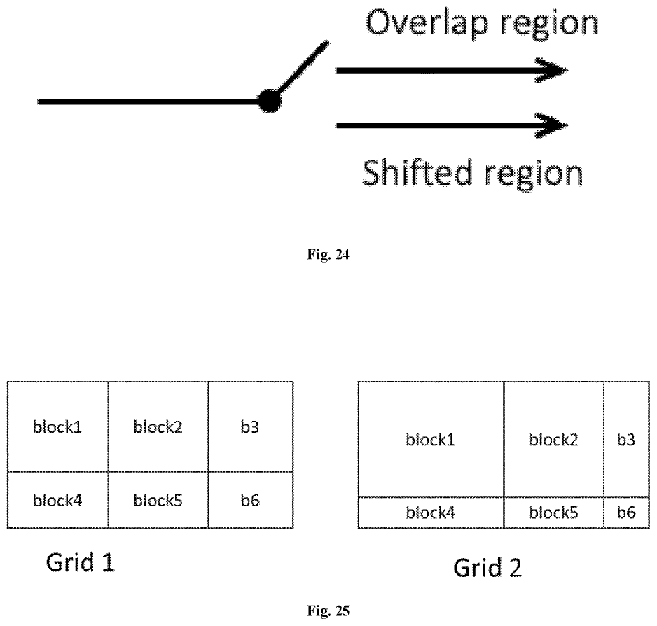

According to some example embodiments of the present disclosure:
At least two different grids are used in encoding or decoding of an image.
   Based on the outcome of a decision, either the first grid is used, or the second grid is used.
      The decision might be based on an indication obtained from the bitstream.
         The indication might be a flag.
         The indication might be a profile indicator.
         The indication might be derived from a picture size, or a model index.
   The first grid and the second grid might be depicted in FIG. 25:
      The first grid and the second grid might comprise different sets of samples.
      The sizes of the blocks in the grid 1 and grid 2 might be different.
      The grid 1 and grid 2 might comprise same number of blocks.
      The size of at least one block of grid1 and grid 2 might be different.
      The grids might have overlapping areas. In FIG. 25, the grid 1 and grid 2 are depicted to have no overlapping area. However, according to some example embodiments of the present disclosure, the blocks of the grids might have overlapping area. In other words, block1 and block2 might have a small subset of samples shared by the two.
   The grid 1 and grid 2 might be used in an entropy decoding process.
      The output of the entropy decoding process might correspond to each block of the grid.
      If there are N blocks in a grid, the entropy decoding process might be applied N times. Output of the entropy decoding process might correspond to each block of the grid.
   The grid 1 and grid 2 might be used in a hyper decoding or hyper scale decoding or a sample prediction (latent sample prediction, latent sample reconstruction or multi-stage context) process.
      The output of the process might correspond to each block of the grid.
      The input of the process might correspond to each block of the grid.
      If there are N blocks in a grid, the process might be applied N times. Output of the process might correspond to each block of the grid.
      If there are N blocks in a grid, the process might be applied N times. Input of the process might correspond to each block of the grid.
   There might be multiple sets of at least two grids.
      For example, there might be two sets of grid 1 and grid 2. The first set of {grid 1 and grid 2} might be used in determining the input of a process (e.g. the process might be an entropy decoding process, a hyper decoding process, a hyper scale decoding process, a sample prediction or sample reconstruction process). The second set of {grid 1 and grid 2} might be used in determining the output of the process.
      In another example the first set of {grid 1 and grid 2} might be used in a first process and second set of {grid 1 and grid 2} might be used in a second process.
   The grids might be constructed as follows:
      The top-left block of the second grid might be bigger in vertical and horizontal dimension than the top-left block of the first grid.
      The bottom-right block of the second grid might be smaller in vertical and horizontal dimension than the top-left block of the first grid.
      The top row of blocks in the second grid might be bigger in vertical dimension than the top row of blocks of the first grid.
      The bottom row of blocks in the second grid might be smaller in vertical dimension than the bottom row of blocks of the first grid.
      The left column of blocks in the second grid might be bigger in vertical dimension than the left column of blocks of the first grid.
      The right column of blocks in the second grid might be smaller in vertical dimension than the right column of blocks of the first grid.
   In one example implementation, the processes of a decoding operation (or an encoding operation) might be divided into two sets.
      The first set of processes might comprise at least one of:
         an entropy decoding/encoding process,
         a hyper decoding/encoding process,
         a hyper scale decoding/encoding process,
         a sample prediction or sample reconstruction process.
      The second set of processes might comprise a synthesis/analysis transform (e.g. an inverse transform operation that performs a transform between latent samples and picture samples).
      According to some example embodiments,
         at least 2 grids (a grid 1 and grid 2) might be used in the processing of the first set of processes. In other words, based on the result of a determination, either a first grid is used, or a second grid is used by the process belonging to the first set of processes.
         As exemplified above, the determination might be performed based on an indication obtained from the bitstream.
         Only of grid is used in the processing of the second set of processes. In other words, no determination is performed, only one grid is used in the second set of processes.
      The decoding/encoding operation comprises the first set and second set of processes.
   The first grid might be used in parallel processing. In other words, if the first grid is used in a process, that process might be parallelized. In other words, samples of a first block of the first grid can be obtained in parallel to the samples of a second block.
   The second grid might be used in sequential processing. In other words, if the second grid is used in a process, that process cannot be parallelized. In other words, samples of a second block of the second grid cannot be obtained in parallel to the samples of a first block.
   The second grid might be used in pipelined processing or pipelining.

### 5.3. Embodiment 3

In another example implementation the overlapping amount of the regions and tiles (e.g. partitions) might be determined with an indication obtained from the bitstream. For example:

| | Descriptor |
|---|---|
| picture_header( ) { | |
| . . . | |
| region_partitioning_flag | u(1) |
| if( region_partitioning_flag ) { | |
| region_granularity_idc | u(4) |
| num_ver_splits_minus1 | u(7) |
| num_hor_splits_minus1 | u(7) |
| regional_access_enabled_flag | u(1) |
| if( regional_access_enabled_flag ) | |
| overlap_for_independent_regions | u(1) |
| for( i = 0; i < NumVerSplits; i++ ) | |
| for(j = 0; j < NumHorSplits; j++ ) | |
| independent_region_flag[ i ][ j ] | u(1) |
| } | |

Overlap_for_independent_regions equal to 0 specifies that overlap amount is set equal to zero for a tile boundary if the tile boundary coincides with an independent region (either the tile is inside the independent region, or the neighboring region is independent region). equal to 1 specifies that overlap amount overlap amount specified by tile_overlap_Luma and tile_overlap_Luma are used for all synthesis transform tiles.

A new indication (e.g. overlap_for_independent_regions) might be included in the bitstream to indicate if overlapping (between the partitions) are allowed for independent regions or not. If for example the indication is true, overlapping might be enabled for the independent regions. If the indication is false, the overlap might be disabled.
In one specific example the indication might control only the operation of the synthesis transform. Other operations (e.g. hyper decoder, hyper scale decoder) might still apply no overlapping even if the indication is true.
In one specific example the indication might control only the operation of the synthesis transform. Other operations (e.g. hyper decoder, hyper scale decoder) might still apply overlapping even if the indication is false.

The new indication overlap_for_independent_regions might be implemented as in the section below. In the section below, latent space tiles are allowed to apply overlapping (e.g. using samples from a neighbor region) if the indication is true.

### Latent Space Tiles

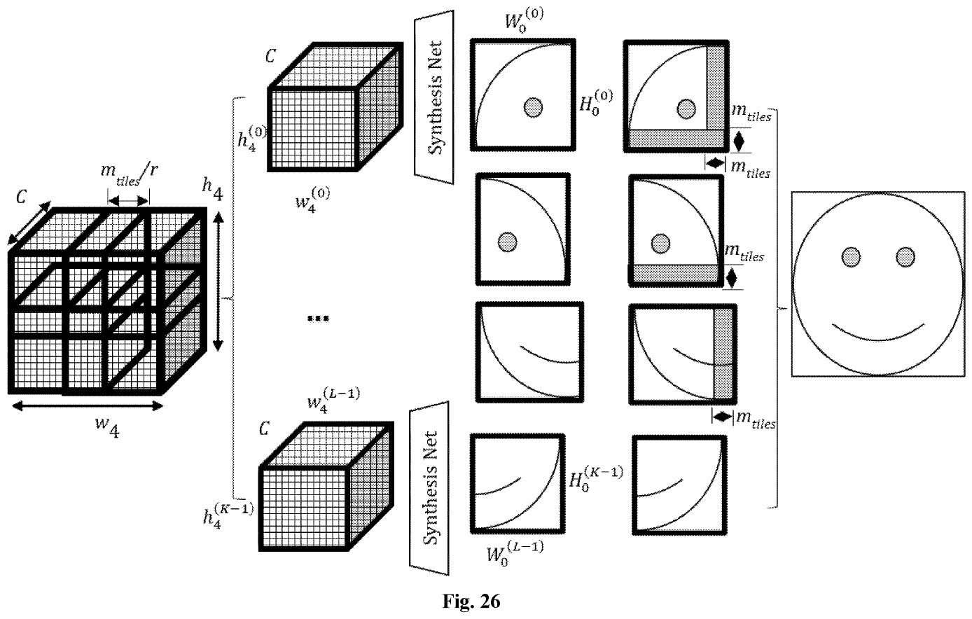

Latent space tiles decoding can be enabled for each component independently by flags signalled in picture header (section 9.3). If tile_enable_Luma or tile_enable_Choma is true then corresponsing component is decoded unsing latent tiling process illustrated on FIG. 26.

The number and location of tiles are determined by values tile size S_{tileHor} and S_{tileVer} (equal to tile_size_Luma hor and tile_size_Luma_ver for primary component and tile_size_Chroma_hor and tile_size_Chroma_ver for secondary component respectively) and tile overlap mₜᵢₗₑ (tile_overlap_Luma for primary component tile overlap_Chroma for secondary component) signalled in picture header (section 9.3). Further, the ratio r=Hᵢₙ/h₄=wᵢₙ/w₄ between signal domain size and latent tensor size is known, which is r=2⁴ for primary and r=2³ for secondary component.

The number of tiles vertically is K=ceil((Hᵢₙ−mₜᵢₗₑ)/(S_{tileVer}−mₜᵢₗₑ)) and horizontally L=ceil ((Wᵢₙ−mₜᵢₗₑ)/(S_{tileHor}−mₜᵢₗₑ)), where Hᵢₙ, Wᵢₙ are height and width of output color plane. Hᵢₙ, Wᵢₙ are hight and width of output color plane.

For k=0, . . . , K−1 and l=0, . . . , L−1,
Define tiles coordinates and sizes
   padₜₒₚ=0 if following conditions are true else mₜᵢₗₑ/2;
      top tile boundary is at image boundary, or
      overlap_for_independent_region==0 and top tile boundary coincide with a region boundary and indepdenent_region_flag is equal to 1 either for the top neighbor region or the region comprising the current tile.
   pad_{bottom}=0 if following conditions are true else mₜᵢₗₑ/2;
      bottom tile boundary is at image boundary, or
      overlap_for_independent_region==0 and bottom tile boundary coincide with a region boundary and indepdenent_region_flag is equal to 1 either for the bottom neighbor region or the region comprising the current tile.
   pad_{left}=0 if following conditions are true else mₜᵢₗₑ/2;
      left tile boundary is at image boundary, or
      overlap_for_independent_region==0 and left tile boundary coincide with a region boundary and indepdenent_region_flag is equal to 1 either for the left neighbor region or the region comprising the current tile.
   pad_{right}=0 if following conditions are true else mₜᵢₗₑ/2;
      right tile boundary is at image boundary, or
      overlap_for_independent_region==0 and right tile boundary coincide with a region boundary and indepdenent_region_flag is equal to 1 either for the right neighbor region or the region comprising the current tile.

$${i}_{0}^{( k )} = k \cdot ( {S}_{t i l e V e r} - {m}_{t i l e} ) - verticle dimension tile start in signal domain ;$$

$${i}_{0}^{( k )} = {i}_{0}^{( k )} - {pad}_{top} if$$

$${i}_{4}^{( k )} = {i}_{0}^{( k )} / r - verticle dimension tile start in latent space ;$$

$${H}_{0}^{( k )} = ( k < K - 1 ) ? {S}_{t i l e V e r - {m}_{tile}} : {H}_{i n} - {i}_{0}^{( k )} - verticle dimension tile size in signal domain ;$$

$${H}_{0}^{( k )} = {H}_{0}^{( k )} + {pad}_{b o t t o m} if$$

$${h}_{4}^{( k )} = ceil ( {H}_{0}^{( k )} / r ) - verticle dimension tile size in latent space ;$$

$${j}_{0}^{( l )} = l \cdot ( {S}_{t i l e H o r} - {m}_{t i l e} ) - horizontal dimension tile start in signal domain ;$$

$${j}_{0}^{( k )} = {j}_{0}^{( k )} - {pad}_{left} if$$

$${j}_{4}^{( l )} = {j}_{0}^{( l )} / r - horizontal dimension tile start in latent space ;$$

$${W}_{0}^{( l )} = ( l < L - 1 ) ? {S}_{t i l e H o r - {m}_{tile}} : {W}_{i n} - {j}_{0}^{( l )} - horizontal dimension tile size in signal domain ;$$

$${W}_{0}^{( k )} = {W}_{0}^{( k )} + {pad}_{right} if$$

$${w}_{4}^{( l )} = ceil ( {W}_{0}^{( l )} / r ) - horizontal dimension tile start in latent space ;$$

tile latent space tensor

$$For c = 0 , … , C - 1 , i = 0 , … , {h}_{4}^{( k )} - 1 and j = 0 , … , {w}_{4}^{( l )} - 1$$

$${\hat{y}}_{k , l} [ c , i , j ] = \hat{y} [ c , {i}_{4}^{( k )} + i , {j}_{4}^{( l )} + j ]$$

$$For c = 0 , … , {C}_{d} - 1 , i = 0 , … , {h}_{4}^{( k )} - 1 and j = 0 , … , {w}_{4}^{( l )} - 1$$

$${\tilde{y}}_{k , l} [ c , i , j ] = \tilde{y} [ c , {i}_{4}^{( k )} + i , {j}_{4}^{( l )} + j ]$$

Synthesis transform for one tile
   Synthesis transform described in section 8.3 with ŷ_{k,l}, \tilde{y}_{k,l} of sizes

$${h}_{4}^{( k )} and {w}_{4}^{( l )}$$

as inputs and \hat{x}_{k,l} of size

$${H}_{0}^{( k )} and {W}_{0}^{( l )}$$

as output.
Merging reconstructed parts of tensor into one
   ov₁=pad_{left}−overlap used on left boundary of the tile;
   ovₜ=padₜₒₚ−overlap used on top boundary of the tile;
   ovᵣ=pad_{right}−overlap used on right boundary of the tile;
   ovₚ=pad_{bottom}−overlap used on bottom boundary of the tile;

$${H}_{1}^{( k )} = {H}_{0}^{( k )} - o {v}_{t} - o {v}_{b}$$

vertical dimension tile size in signal domain without tile overlap;

$${W}_{1}^{( l )} = {W}_{0}^{( l )} - o {v}_{1} - o {v}_{r}$$

horizontal dimension tile size in signal domain without tile overlap;
For

$$c = 0 , … , {C}_{i n} - 1 , i = 0 , … , {H}_{1}^{( k )} - 1 and j = 0 , … , {W}_{1}^{( l )} - 1 ,$$

$$\hat{x} [ c , {i}_{0}^{( k )} + o {v}_{t} + i , {j}_{0}^{( l )} + o {v}_{1} + j ] = {\hat{x}}_{k , l} [ c , o {v}_{t} + i , o {v}_{1} + j ] .$$

Tile size location and overlap signalling in Picture Header is described in Annex C.

### 5.4. Embodiment 4

Additionally or alternatively to all above, the overlapping amount might depend on:
An indication related to a current region (e.g. an independent region flag corresponding to the current region);
An indicartion related to a neighbor region (e.g. an independent region flag corresponding to the neighbor region);
Both.

For example if the indication is equal to true for a current region (e.g. the current region is independent), the overlap amount might be set equal to zero for the current region or part of the current region.

In another example if the indication is equal to true for a neighbor region (e.g. the neighbor region is independent), the overlap amount might be set equal to zero for the current region or part of the current region or at a boundary of the current region (e.g. the boundary between the current and the neighbor region).

An example implementation might be as follows. According to the example, the overlap amount is controlled by the parameters pad_{left}, pad_{right}, padₜₒₚ, pad_{bottom}. The amount of overlap is determined by the independent_region_flag of the current region as follows:
ext=independent_region_flag[Vtile] [Htile]?1:0.

Moreover the overlap amount is determined by the independent_region_flag of the neighbor region as follows, wherein the independent_region_flag[Vtile] [Htile−1] is the independent flag of the left neighbor:
pad_{left}=ext if Htile>0 and independent_region_flag[Vtile] [Htile−1]==0 else 0;
pad_{right}=ext if Htile<NumVerSplits−1 and independent_region_flag[Vtile] [Htile+1]==0 else 0;
padₜₒₚ=ext if Vtile>0 and independent_region_flag[Vtile−1] [Htile]==0 else 0;
pad_{bottom}=ext if Vtile<NumHorSplits−1 and independent_region_flag[Vtile+1][Htile]==0 else 0.

### Hyper Decoder

The learning-based hyper decoder consists of two independent pipe-lines with identical neural network architecture, except input size and number of channels.

The input of this process is
\hat{z}[C, h₆, w₆] reconstructed hyper latent tensor,
model parameters for Hyper Decoder Net defined by (modelldx),
operation point indicator opldx.
   The Output of this Process is
p[Cₚ, h₄, w₄] is explicit prediction (part of prediction tensor derived from explicitly signalled information), with channels size Cₚ=(opIdx+1)C.

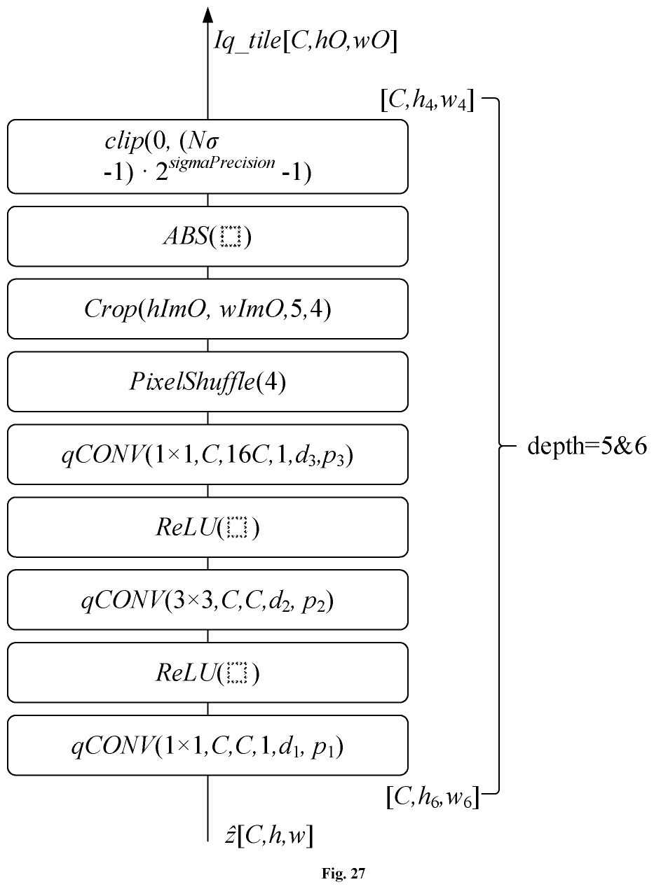

Hyper decoder process is depicted in FIG. 27.

Hyper decoder starts stride 1 convolution with kernel size 1×1, followed by inverse convolution (stride 2, kernel size 4×4), cropping layer (depth 6) and leacky rectified linear unit. Next step is stride 1 convolution with kernel size 3×3, followed by inverse convolution (stride 2, kernel size 4×4), cropping layer (depth 5) and leacky rectified linear unit. Number of channels kep un-changed till this point (equal to number of channels C of input tensor). Hyper decoder concluded by stride 1 convolution with kernel size 3×3 which increases number of channels to 2C for high operation point and keeps number fo channes unchanged for base operation point followed by leacky rectified linear unit.

The hyper decoder operation is applied in tiled manner. The following are the processing:
for Vtile=0 . . . . NumHorSplits−1 and Htile=0 . . . Num VerSplits−1
   ext=independent_region_flag[Vtile][Htile]? 1:0
   pad_{left}=ext if Htile>0 and independent_region_flag[Vtile][Htile−1]==0 else 0
   pad_{right}=ext if Htile<NumVerSplits−1 and independent_region_flag[Vtile][Htile+1]==0 else 0
   padₜₒₚ=ext if Vtile>0 and independent_region_flag[Vtile−1][Htile]==0 else 0
   pad_{bottom}=ext if Vtile<NumHorSplits−1 and independent_region_flag[Vtile+1][Htile]==0 else 0
   y=RC[6][Vtile][Htile][0]−pad_top
   x=RC[6][Vtile][Htile][1]−pad_left
   yO=RC[4][Vtile][Htile][0]
   xO=RC[4][Vtile][Htile][1]
   h=RC[6][Vtile][Htile][4]+pad_top+pad_bottom
   w=RC[6][Vtile][Htile][5]+pad_left+pad_right
   hO=RC[4][Vtile][Htile][4]+pad_top+4+pad_bottom*4
   wO=RC[4][Vtile][Htile][5]+pad_left*4+pad_right*4
   hImO=RC[0][Vtile][Htile][4]+pad_top*64+pad_bottom*64
   wImO=RC[0][Vtile][Htile][5]+pad_left*64+pad_right*64
   the tensor part \hat{z}[C, y . . . y+h−1, x . . . x+w−1] is fed into the hyper decoder to obtain the tensor p_tile[Cₚ, hO, wO].
   p[Cₚ, yO . . . RC[4][Vtile][Htile][1]−1, xO . . . RC[4][Vtile][Htile][3]−1]=p_tile[Cₚ, padₜₒₚ*4 . . . RC[4][Vtile][Htile][4]+padₜₒₚ−1, pad_{left}*4 . . . RC[4][Vtile][Htile][5]+pad_{left}+1].

Model with weights are storied in electronic attachment, in format specified in section 4.8 and locates in <oper_point>/model_<MID>/<COMP>/hyper_decoder.onnx, where <oper_point> is “base” or “high”, <MID> is an integer from 0 to 5, <COMP> is “primary” or “secondary”.

### 5.5. Embodiment 5

Additionally or alternatively, padding might be applied at the boundaries of a partition.

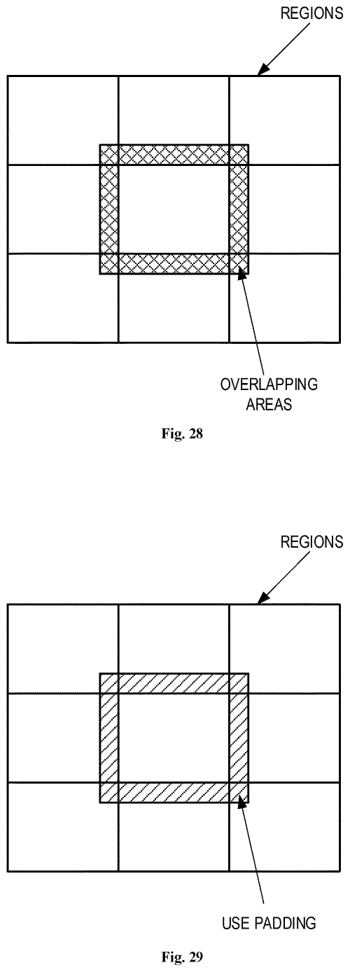

For example an extension might applied around the partition boundaries. And overlapping partitions are applied (e.g. samples from a neighbor partition might be used) in the decoding process. This is exemplified in FIG. 28. In another example an extension might applied around the partition boundaries. Padding is applied at the extension region (e.g. samples from a current partition are used) in the decoding process. This is exemplified in FIG. 29.

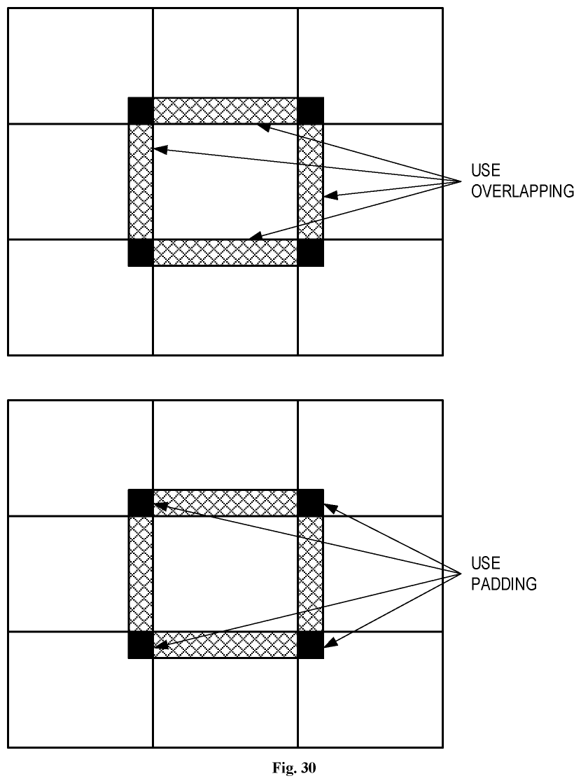

In another example an extension might applied around the partition boundaries. Both padding and overlapping might be applied at the extension region. This is exemplified in FIG. 30.

The padding or overlapping might be applied to different parts of the extension:
Corner samples of the extension might use padding.
Samples that are not at the corner might apply overlapping.
If a sample is at the extension section of a first partition, and at the same time it is inside a core part of second partition;
   a. If the second partition is independent partition, padding might be applied.
   b. If the second partition is dependent partition, overlapping might be applied.
   c. If the first partition is independent partition, padding might be applied.
   d. If the first partition is dependent partition, overlapping might be applied.
      Partition might be a region, a tile, a synthesis transform tile etc.

More details of the embodiments of the present disclosure will be described below which are related to neural network-based visual data coding. As used herein, the term “visual data” may refer to an image, a video, a picture in a video, or any other visual data suitable to be coded. To solve the above problems and some other problems not mentioned, visual data processing solutions as described below are disclosed. The embodiments of the present disclosure should be considered as examples to explain the general concepts and should not be interpreted in a narrow way. Furthermore, these embodiments can be applied individually or combined in any manner.

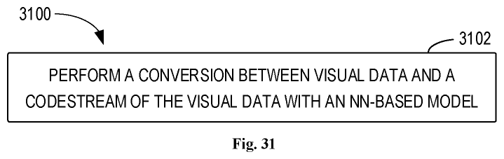

FIG. 31 illustrates a flowchart of a method 3100 for visual data processing in accordance with some embodiments of the present disclosure. At 3102, a conversion between the visual data and a codestream of the visual data is performed with a neural network (NN)-based model. For example, a codestream may comprise a sequence of bits. In addition, the codestream may further comprise associated codes which are used as markers. As used herein, the codestream may also be referred to as a bitstream.

In some embodiments, the conversion may include encoding the visual data into the codestream. Additionally or alternatively, the conversion may include decoding the visual data from the codestream. By way of example rather than limitation, the decoding model shown in FIG. 6 may be employed for decoding the visual data from the bitstream.

As used herein, an NN-based model may be a model based on neural network technologies. For example, an NN-based model may specify sequence of neural network modules (also called architecture) and model parameters. The neural network module may comprise a set of neural network layers. Each neural network layer specifies a tensor operation which receives and outputs tensor, and each layer has trainable parameters. It should be understood that the possible implementations of the NN-based model described here are merely illustrative and therefore should not be construed as limiting the present disclosure in any way.

In addition, samples associated with the visual data are partitioned into a plurality of partitions. In one example embodiment, the samples associated with the visual data may be samples in the visual data. In another example embodiment, the samples associated with the visual data may be samples in a latent representation of the visual data. As used herein, a sample in the latent representation may also be referred to as a latent sample. In a further example embodiment, the samples associated with the visual data may be samples in a residual latent representation of the visual data. As used herein, a sample in the residual latent representation may also be referred to as a residual sample. In a still further example embodiment, the samples associated with the visual data may be samples in a hyper tensor or quantized hyper tensor for the visual data. It should be understood that the possible implementations of the samples associated with the visual data described here are merely illustrative and therefore should not be construed as limiting the present disclosure in any way.

Moreover, the codestream is allowed to comprise a first indication indicating an amount of overlap for the plurality of partitions that is used in a hyper decoding process of the NN-based model. The hyper decoding process may be implemented with a hyper decoder and may also be referred to as a hyper decoder process. For example, the input of the hyper decoding process may comprise reconstructed hyper tensor and model parameters for hyper decoder network, and the output of the hyper decoding process may comprise re-shuffled explicit prediction tensor, which is the part of prediction tensor derived from explicitly signaled information. By way of example rather than limitation, the first indication may specify the amount of overlap used in the hyper decoding process in number of latent samples.

Additionally or alternatively, the codestream is allowed to comprise a second indication indicating an amount of overlap for the plurality of partitions that is used in a multistage context modelling (MCM) process of the NN-based model. For example, the input of the MCM process may comprise a reconstructed residual tensor (e.g., a tensor of reconstructed residual samples), and a re-shuffled explicit prediction tensor which is the output of the above-mentioned hyper decoder, and the output of the MCM process may comprise a reconstructed latent tensor (e.g., a tensor of reconstructed latent samples). By way of example rather than limitation, the second indication may specify the amount of overlap used in the MCM process in number of latent samples.

In view of the above, samples associated with the visual data are partitioned into a plurality of partitions, and an amount of overlap for the plurality of partitions that is used in one or more processes of the NN-based model is indicated in the codestream. Compared with the conventional solution where the amount of overlap is fixed and predetermined, the proposed method can provide a mechanism for signaling of overlap amount information, and thus can better support the application of different overlap amounts for different processes. Thereby, the coding flexibility can be improved.

In some embodiments, an amount of overlap for the plurality of partitions that is used in at least one processing process of the NN-based model may be determined based on a third indication in the codestream. By way of example rather than limitation, the at least one processing process may comprise the hyper decoding process, the MCM process, a synthesis transform process, a latent sample reconstruction process, a sample prediction process, an analysis transform process, a hyper scale decoding process, and/or the like. For example, in the analysis transform process, samples of the visual data that are in the pixel domain are transformed into samples in a latent domain, so as to obtain the latent representation of the visual data. The synthesis transform process may be regard as an inverse process of the analysis transform process. More specifically, in the synthesis transform process, reconstructed samples in latent domain are transformed into samples in the pixel domain, so as to obtain the reconstructed pixels of the visual data.

In one example embodiment, whether the amount of overlap that is used in the at least one processing process is equal to zero may be determined based on the third indication. For example, the third indication may indicate whether the primary or secondary residual data for each region is in a substream. In a case where the third indication indicates that the primary or secondary residual data for each region is in a substream, the residual samples for each region can be decoded independently from other regions, and thus the amount of overlap that is used in the at least one processing process may be determined to be zero. In a case where the third indication indicates that there is only one substream for primary and only one substream for secondary residual data, the residual samples for each region are decoded dependently on samples from other regions, and thus the amount of overlap that is used in the at least one processing process may be determined to be non-zero.

In addition, whether the codestream comprises the first indication and the second indication may be dependent on the third indication. For example, in accordance with a determination that the amount of overlap that is used in the at least one processing process is zero, the first indication and the second indication may be absent from the codestream. In accordance with a determination that the amount of overlap that is used in the at least one processing process is non-zero, the first indication and the second indication may be comprised in the codestream. Thereby, the number of bits for signaling the first indication and the second indication can be saved in a case where the amount of overlap is determined to be zero based on the third indication.

In some embodiments, one of the plurality of partitions may comprise a region or a tile. By way of example, for the hyper decoding process and/or the MCM process, a region cannot be further divided into a plurality of tiles, and in this case, a region may be equivalent to a tile. For the synthesis transform process, a region may be divided into a plurality of tiles. In case where the third indication indicates that the primary or secondary residual data for each region is in a substream, the amount of overlap between two tiles within the same region may be greater than zero, while the mount of overlap between two tiles from different regions shall be zero. In a case where the third indication indicates that there is only one substream for primary and only one substream for secondary residual data, both the amount of overlap between two tiles within the same region and the mount of overlap between two tiles from different regions may be greater than zero.

In some embodiments, the codestream may comprise a fourth indication indicating whether overlapping is allowed for independent regions. For example, an independent region may refer to a region which can be decoded independently from samples of other regions. By way of example rather than limitation, the fourth indication may be denoted as overlap_for_independent_regions or the like.

In some embodiments, an amount of overlap used in a synthesis transform process of the NN-based model may be dependent on the fourth indication. In addition, an amount of overlap used in a first processing process, that is different from the synthesis transform process, of the NN-based model may be independent from the fourth indication. For example, the first processing process may comprise the hyper decoding process, the MCM process, the hyper scale decoding process, and/or the like.

In some embodiments, the fourth indication equal to a first value indicates that tiles from different independent regions are not allowed to overlap, and the fourth indication equal to a second value indicates that tiles from different independent regions is allowed to overlap.

In some embodiments, the codestream comprises a plurality of fifth indications. Each of the plurality of fifth indications corresponds to one of the plurality of partitions and indicates whether the corresponding partition is coded independently from rest of the plurality of partitions. An amount of overlap for a current partition among the plurality of partitions may be dependent on the fifth indication corresponding to the current partition, and/or the fifth indication corresponding to a neighboring partition of the current partition.

In one example embodiment, in accordance with a determination that the fifth indication corresponding to the current partition indicates that the current partition is coded independently from rest of the plurality of partitions, at least one of the following may be zero: an amount of overlap used for the entire current partition, or an amount of overlap used for a part of the current partition. Additionally or alternatively, in accordance with a determination that the fifth indication corresponding to the neighboring partition indicates that the neighboring partition is coded independently from rest of the plurality of partitions, at least one of the following may be zero: an amount of overlap used for the entire current partition, an amount of overlap used for a part of the current partition, or an amount of overlap between the current partition and the neighboring partition.

In some embodiments, at least one of padding or overlapping may be applied to obtain values for a set of samples outside a first partition among the plurality of partitions. In a case where padding is applied to obtain values for samples outside of the first partition, samples within the first partition are used to extrapolate values for the samples outside of the first partition. In a case where overlapping is applied to obtain values for samples outside of the first partition, samples of one or more partitions neighboring to the first partition are used to determine values for the samples outside of the first partition.

In some embodiments, values for samples among the set of samples that are at a corner may be obtained based on padding, as shown in the bottom part of the FIG. 30. Values for samples among the set of samples that are not at the corner may be obtained based on overlapping, as shown in the upper part of the FIG. 30.

In some embodiments, the set of samples may comprise a first sample, and whether padding or overlapping is applied to obtain a value for the first sample may be dependent on whether the first partition is coded independently from rest of the plurality of partitions. By way of example, in accordance with a determination that the first partition is coded independently from the rest of the plurality of partitions, padding may be applied to obtain the value for the first sample. In accordance with a determination that the first partition is not coded independently from the rest of the plurality of partitions, overlapping may be applied to obtain the value for the first sample.

In some embodiments, the set of samples may comprise a second sample located in a second partition among the plurality of partitions. Whether padding or overlapping is applied to obtain a value for the second sample may be dependent on whether the second partition is coded independently from rest of the plurality of partitions. By way of example, in accordance with a determination that the second partition is coded independently from the rest of the plurality of partitions, padding may be applied to obtain the value for the second sample. In accordance with a determination that the second partition is not coded independently from the rest of the plurality of partitions, overlapping may be applied to obtain the value for the second sample.

In view of the above, the solutions in accordance with some embodiments of the present disclosure can advantageously improve coding efficiency and coding flexibility.

According to further embodiments of the present disclosure, a non-transitory computer-readable recording medium is provided. The non-transitory computer-readable recording medium stores a codestream of visual data which is generated by a method performed by an apparatus for visual data processing. The method comprises: performing a conversion between the visual data and the codestream with a neural network (NN)-based model, wherein samples associated with the visual data are partitioned into a plurality of partitions, and the codestream is allowed to comprise at least one of the following: a first indication indicating an amount of overlap for the plurality of partitions that is used in a hyper decoding process of the NN-based model, or a second indication indicating an amount of overlap for the plurality of partitions that is used in a multistage context modelling (MCM) process of the NN-based model.

According to still further embodiments of the present disclosure, a method for storing codestream of visual data is provided. The method comprises: performing a conversion between the visual data and the codestream with a neural network (NN)-based model; and storing the codestream in a non-transitory computer-readable recording medium, wherein samples associated with the visual data are partitioned into a plurality of partitions, and the codestream is allowed to comprise at least one of the following: a first indication indicating an amount of overlap for the plurality of partitions that is used in a hyper decoding process of the NN-based model, or a second indication indicating an amount of overlap for the plurality of partitions that is used in a multistage context modelling (MCM) process of the NN-based model.

Implementations of the present disclosure can be described in view of the following clauses, the features of which can be combined in any reasonable manner.
Clause 1. A method for visual data processing, comprising: performing a conversion between visual data and a codestream of the visual data with a neural network (NN)-based model, wherein samples associated with the visual data are partitioned into a plurality of partitions, and the codestream is allowed to comprise at least one of the following: a first indication indicating an amount of overlap for the plurality of partitions that is used in a hyper decoding process of the NN-based model, or a second indication indicating an amount of overlap for the plurality of partitions that is used in a multistage context modelling (MCM) process of the NN-based model.
Clause 2. The method of clause 1, wherein an amount of overlap for the plurality of partitions that is used in at least one processing process of the NN-based model is determined based on a third indication in the codestream.
Clause 3. The method of clause 2, wherein the at least one processing process comprises at least one of the following: the hyper decoding process, the MCM process, a synthesis transform process, a latent sample reconstruction process, a sample prediction process, an analysis transform process, or a hyper scale decoding process.
Clause 4. The method of any of clauses 2-3, wherein in accordance with a determination that the amount of overlap that is used in the at least one processing process is zero, the first indication and the second indication are absent from the codestream, or in accordance with a determination that the amount of overlap that is used in the at least one processing process is non-zero, the first indication and the second indication are comprised in the codestream.
Clause 5. The method of any of clauses 1-4, wherein one of the plurality of partitions comprises a region or a tile.
Clause 6. The method of any of clauses 1-5, wherein the codestream comprises a fourth indication indicating whether overlapping is allowed for independent regions.
Clause 7. The method of clause 6, wherein an amount of overlap used in a synthesis transform process of the NN-based model is dependent on the fourth indication.
Clause 8. The method of any of clauses 6-7, wherein an amount of overlap used in a first processing process of the NN-based model is independent from the fourth indication, and the first processing process is different from a synthesis transform process.
Clause 9. The method of any of clauses 6-8, wherein the fourth indication equal to a first value indicates that tiles from different independent regions are not allowed to overlap, and the fourth indication equal to a second value indicates that tiles from different independent regions are allowed to overlap.
Clause 10. The method of any of clauses 1-9, wherein the codestream comprises a plurality of fifth indications, each of the plurality of fifth indications corresponds to one of the plurality of partitions and indicates whether the corresponding partition is coded independently from rest of the plurality of partitions, and an amount of overlap for a current partition among the plurality of partitions is dependent on at least one of the following: the fifth indication corresponding to the current partition, or the fifth indication corresponding to a neighboring partition of the current partition.
Clause 11. The method of clause 10, wherein in accordance with a determination that the fifth indication corresponding to the current partition indicates that the current partition is coded independently from rest of the plurality of partitions, at least one of the following is zero: an amount of overlap used for the entire current partition, or an amount of overlap used for a part of the current partition.
Clause 12. The method of clause 10, wherein in accordance with a determination that the fifth indication corresponding to the neighboring partition indicates that the neighboring partition is coded independently from rest of the plurality of partitions, at least one of the following is zero: an amount of overlap used for the entire current partition, an amount of overlap used for a part of the current partition, or an amount of overlap between the current partition and the neighboring partition.
Clause 13. The method of any of clauses 1-12, wherein at least one of padding or overlapping is applied to obtain values for a set of samples outside a first partition among the plurality of partitions.
Clause 14. The method of clause 13, wherein values for samples among the set of samples that are at a corner are obtained based on padding, and values for samples among the set of samples that are not at the corner are obtained based on overlapping.
Clause 15. The method of clause 13, wherein the set of samples comprises a first sample, and whether padding or overlapping is applied to obtain a value for the first sample is dependent on whether the first partition is coded independently from rest of the plurality of partitions.
Clause 16. The method of clause 15, wherein in accordance with a determination that the first partition is coded independently from the rest of the plurality of partitions, padding is applied to obtain the value for the first sample, or in accordance with a determination that the first partition is not coded independently from the rest of the plurality of partitions, overlapping is applied to obtain the value for the first sample.
Clause 17. The method of clause 13, wherein the set of samples comprises a second sample located in a second partition among the plurality of partitions, and whether padding or overlapping is applied to obtain a value for the second sample is dependent on whether the second partition is coded independently from rest of the plurality of partitions.
Clause 18. The method of clause 17, wherein in accordance with a determination that the second partition is coded independently from the rest of the plurality of partitions, padding is applied to obtain the value for the second sample, or in accordance with a determination that the second partition is not coded independently from the rest of the plurality of partitions, overlapping is applied to obtain the value for the second sample.
Clause 19. The method of any of clauses 1-18, wherein the visual data comprise a picture of a video, or an image.
Clause 20. The method of any of clauses 1-19, wherein the conversion includes encoding the visual data into the codestream.
Clause 21. The method of any of clauses 1-19, wherein the conversion includes decoding the visual data from the codestream.
Clause 22. An apparatus for visual data processing comprising a processor and a non-transitory memory with instructions thereon, wherein the instructions upon execution by the processor, cause the processor to perform a method in accordance with any of clauses 1-21.
Clause 23. A non-transitory computer-readable storage medium storing instructions that cause a processor to perform a method in accordance with any of clauses 1-21.
Clause 24. A non-transitory computer-readable recording medium storing a codestream of visual data which is generated by a method performed by an apparatus for visual data processing, wherein the method comprises: performing a conversion between the visual data and the codestream with a neural network (NN)-based model, wherein samples associated with the visual data are partitioned into a plurality of partitions, and the codestream is allowed to comprise at least one of the following: a first indication indicating an amount of overlap for the plurality of partitions that is used in a hyper decoding process of the NN-based model, or a second indication indicating an amount of overlap for the plurality of partitions that is used in a multistage context modelling (MCM) process of the NN-based model.
Clause 25. A method for storing a codestream of visual data, comprising: performing a conversion between the visual data and the codestream with a neural network (NN)-based model; and storing the codestream in a non-transitory computer-readable recording medium, wherein samples associated with the visual data are partitioned into a plurality of partitions, and the codestream is allowed to comprise at least one of the following: a first indication indicating an amount of overlap for the plurality of partitions that is used in a hyper decoding process of the NN-based model, or a second indication indicating an amount of overlap for the plurality of partitions that is used in a multistage context modelling (MCM) process of the NN-based model.

### Example Device

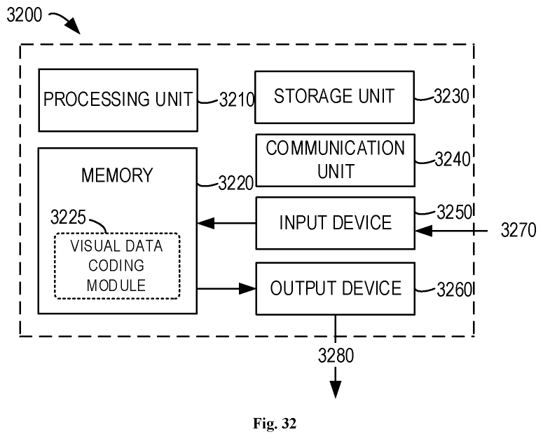

FIG. 32 illustrates a block diagram of a computing device 3200 in which various embodiments of the present disclosure can be implemented. The computing device 3200 may be implemented as or included in the source device 110 (or the visual data encoder 114) or the destination device 120 (or the visual data decoder 124).

It would be appreciated that the computing device 3200 shown in FIG. 32 is merely for purpose of illustration, without suggesting any limitation to the functions and scopes of the embodiments of the present disclosure in any manner.

As shown in FIG. 32, the computing device 3200 includes a general-purpose computing device 3200. The computing device 3200 may at least comprise one or more processors or processing units 3210, a memory 3220, a storage unit 3230, one or more communication units 3240, one or more input devices 3250, and one or more output devices 3260.

In some embodiments, the computing device 3200 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 3200 can support any type of interface to a user (such as “wearable” circuitry and the like).

The processing unit 3210 may be a physical or virtual processor and can implement various processes based on programs stored in the memory 3220. In a multi-processor system, multiple processing units execute computer executable instructions in parallel so as to improve the parallel processing capability of the computing device 3200. The processing unit 3210 may also be referred to as a central processing unit (CPU), a microprocessor, a controller or a microcontroller.

The computing device 3200 typically includes various computer storage medium. Such medium can be any medium accessible by the computing device 3200, including, but not limited to, volatile and non-volatile medium, or detachable and non-detachable medium. The memory 3220 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 3230 may be any detachable or non-detachable medium and may include a machine-readable medium such as a memory, flash memory drive, magnetic disk or another other media, which can be used for storing information and/or visual data and can be accessed in the computing device 3200.

The computing device 3200 may further include additional detachable/non-detachable, volatile/non-volatile memory medium. Although not shown in FIG. 32, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more visual data medium interfaces.

The communication unit 3240 communicates with a further computing device via the communication medium. In addition, the functions of the components in the computing device 3200 can be implemented by a single computing cluster or multiple computing machines that can communicate via communication connections. Therefore, the computing device 3200 can operate in a networked environment using a logical connection with one or more other servers, networked personal computers (PCs) or further general network nodes.

The input device 3250 may be one or more of a variety of input devices, such as a mouse, keyboard, tracking ball, voice-input device, and the like. The output device 3260 may be one or more of a variety of output devices, such as a display, loudspeaker, printer, and the like. By means of the communication unit 3240, the computing device 3200 can further communicate with one or more external devices (not shown) such as the storage devices and display device, with one or more devices enabling the user to interact with the computing device 3200, or any devices (such as a network card, a modem and the like) enabling the computing device 3200 to communicate with one or more other computing devices, if required. Such communication can be performed via input/output (I/O) interfaces (not shown).

In some embodiments, instead of being integrated in a single device, some or all components of the computing device 3200 may also be arranged in cloud computing architecture. In the cloud computing architecture, the components may be provided remotely and work together to implement the functionalities described in the present disclosure. In some embodiments, cloud computing provides computing, software, visual data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding visual data may be stored on a server at a remote position. The computing resources in the cloud computing environment may be merged or distributed at locations in a remote visual data center. Cloud computing infrastructures may provide the services through a shared visual data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 3200 may be used to implement visual data encoding/decoding in embodiments of the present disclosure. The memory 3220 may include one or more visual data coding modules 3225 having one or more program instructions. These modules are accessible and executable by the processing unit 3210 to perform the functionalities of the various embodiments described herein.

In the example embodiments of performing visual data encoding, the input device 3250 may receive visual data as an input 3270 to be encoded. The visual data may be processed, for example, by the visual data coding module 3225, to generate an encoded bitstream. The encoded bitstream may be provided via the output device 3260 as an output 3280.

In the example embodiments of performing visual data decoding, the input device 3250 may receive an encoded bitstream as the input 3270. The encoded bitstream may be processed, for example, by the visual data coding module 3225, to generate decoded visual data. The decoded visual data may be provided via the output device 3260 as the output 3280.

While this disclosure has been particularly shown and described with references to example embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

I/We claim:

1. A method for visual data processing, comprising:
performing a conversion between visual data and a codestream of the visual data with a neural network (NN)-based model, wherein samples associated with the visual data are partitioned into a plurality of partitions, and the codestream is allowed to comprise at least one of the following:
a first indication indicating an amount of overlap for the plurality of partitions that is used in a hyper decoding process of the NN-based model, or
a second indication indicating an amount of overlap for the plurality of partitions that is used in a multistage context modelling (MCM) process of the NN-based model.

2. The method of claim 1, wherein an amount of overlap for the plurality of partitions that is used in at least one processing process of the NN-based model is determined based on a third indication in the codestream.

3. The method of claim 2, wherein the at least one processing process comprises at least one of the following:
the hyper decoding process,
the MCM process,
a synthesis transform process,
a latent sample reconstruction process,
a sample prediction process,
an analysis transform process, or
a hyper scale decoding process.

4. The method of claim 2, wherein in accordance with a determination that the amount of overlap that is used in the at least one processing process is zero, the first indication and the second indication are absent from the codestream, or
in accordance with a determination that the amount of overlap that is used in the at least one processing process is non-zero, the first indication and the second indication are comprised in the codestream.

5. The method of claim 1, wherein one of the plurality of partitions comprises a region or a tile.

6. The method of claim 1, wherein the codestream comprises a fourth indication indicating whether overlapping is allowed for independent regions, or
wherein the codestream comprises a plurality of fifth indications, each of the plurality of fifth indications corresponds to one of the plurality of partitions and indicates whether the corresponding partition is coded independently from rest of the plurality of partitions, and an amount of overlap for a current partition among the plurality of partitions is dependent on at least one of the following: the fifth indication corresponding to the current partition, or the fifth indication corresponding to a neighboring partition of the current partition, or
wherein at least one of padding or overlapping is applied to obtain values for a set of samples outside a first partition among the plurality of partitions.

7. The method of claim 1, wherein the visual data comprise a picture of a video, or an image.

8. The method of claim 1, wherein the conversion includes encoding the visual data into the codestream.

9. The method of claim 1, wherein the conversion includes decoding the visual data from the codestream.

10. The method of claim 1, wherein the conversion comprises: generating the codestream from the visual data, and
the method further comprises: storing the codestream in a non-transitory computer-readable recording medium.

11. An apparatus for visual data processing comprising a processor and a non-transitory memory with instructions thereon, wherein the instructions upon execution by the processor, cause the processor to perform operations comprising:
performing a conversion between visual data and a codestream of the visual data with a neural network (NN)-based model, wherein samples associated with the visual data are partitioned into a plurality of partitions, and the codestream is allowed to comprise at least one of the following:
a first indication indicating an amount of overlap for the plurality of partitions that is used in a hyper decoding process of the NN-based model, or
a second indication indicating an amount of overlap for the plurality of partitions that is used in a multistage context modelling (MCM) process of the NN-based model.

12. The apparatus of claim 11, wherein an amount of overlap for the plurality of partitions that is used in at least one processing process of the NN-based model is determined based on a third indication in the codestream.

13. The apparatus of claim 12, wherein the at least one processing process comprises at least one of the following:
the hyper decoding process,
the MCM process,
a synthesis transform process,
a latent sample reconstruction process,
a sample prediction process,
an analysis transform process, or
a hyper scale decoding process.

14. The apparatus of claim 12, wherein in accordance with a determination that the amount of overlap that is used in the at least one processing process is zero, the first indication and the second indication are absent from the codestream, or
in accordance with a determination that the amount of overlap that is used in the at least one processing process is non-zero, the first indication and the second indication are comprised in the codestream.

15. The apparatus of claim 11, wherein one of the plurality of partitions comprises a region or a tile.

16. A non-transitory computer-readable storage medium storing instructions that cause a processor to perform operations comprising:
performing a conversion between visual data and a codestream of the visual data with a neural network (NN)-based model, wherein samples associated with the visual data are partitioned into a plurality of partitions, and the codestream is allowed to comprise at least one of the following:
a first indication indicating an amount of overlap for the plurality of partitions that is used in a hyper decoding process of the NN-based model, or
a second indication indicating an amount of overlap for the plurality of partitions that is used in a multistage context modelling (MCM) process of the NN-based model.

17. The non-transitory computer-readable storage medium of claim 16, wherein an amount of overlap for the plurality of partitions that is used in at least one processing process of the NN-based model is determined based on a third indication in the codestream.

18. The non-transitory computer-readable storage medium of claim 17, wherein the at least one processing process comprises at least one of the following:
the hyper decoding process,
the MCM process,
a synthesis transform process,
a latent sample reconstruction process,
a sample prediction process,
an analysis transform process, or
a hyper scale decoding process.

19. The non-transitory computer-readable storage medium of claim 17, wherein in accordance with a determination that the amount of overlap that is used in the at least one processing process is zero, the first indication and the second indication are absent from the codestream, or
in accordance with a determination that the amount of overlap that is used in the at least one processing process is non-zero, the first indication and the second indication are comprised in the codestream.

20. The non-transitory computer-readable storage medium of claim 16, wherein one of the plurality of partitions comprises a region or a tile.
